(19) United States
(12) Patent Application Publication
(10) Pub. No.: US 2026/0359792 A1
(43) Pub. Date: Nov. 12, 2026

(54) SYSTEM AND METHOD FOR EXCHANGE OF RESUMES

(71) Applicants: Hrydyesh Garg, Dallas, TX (US); Rudraksh Garg, Dallas, TX (US); Tridhm Garg, Dallas, TX (US)

(72) Inventors: Hrydyesh Garg, Dallas, TX (US); Rudraksh Garg, Dallas, TX (US); Tridhm Garg, Dallas, TX (US)

(21) Appl. No.: 19/647,827

(22) Filed: Apr. 14, 2026

Related U.S. Application Data
(60) Provisional application No. 63/788,737, filed on Apr. 14, 2025.

(51) Int. Cl. G06Q 10/1053

(52) U.S. Cl. CPC G06Q 10/1053

(57) ABSTRACT

In some implementations, the device can perform the following: receive and store information about a first candidate in a first database, enable access to this information for a first user profile, extract and store abstract data from this information in a second database, and associate the abstract data with the first user profile and a first token value. The device can determine if the abstract data is authorized for publication and publish it to a publicly searchable database if authorized. Additionally, the device can handle a request from a second user profile to transfer the candidate's information, receiving the first token value to authorize the transfer to the second user profile.

### BACKGROUND

### Technical Field

The present disclosure relates to the field of data exchange and more particularly to a system and method for providing an exchange service for resumes, talent profiles, biodata and/or other personal information.

### Background

In the realm of talent acquisition, the recruiter's paramount task is striking a delicate balance between speed and accuracy when finding the right candidate. While speed ensures that crucial positions are filled swiftly, accuracy ensures that the chosen candidate is the best fit for the role and the organization's culture. The ability to swiftly identify and engage with top talent is a competitive advantage, but it should ideally not come at the cost of making hasty, ill-informed decisions. A recruiter's task should be harness the latest technology, employ effective search methodologies, and possess a deep understanding of the roles' requirements to streamline the recruitment process. Ultimately, the recruiters' successes are measured not only by how quickly they fill positions but by the long-term success and contribution of the candidates they place, highlighting the importance of both speed and accuracy in the recruitment endeavor.

Identifying ideal candidates with speed and accuracy on career websites can often be a daunting and arduous task. Several factors contribute to the formidable challenges faced by recruiters and employers in this digital age of talent acquisition.

First, the sheer volume of resumes and profiles uploaded to these platforms is staggering. Career sites serve as a repository for job seekers from all walks of life. It generally requires a significant investment of time and effort to identify those individuals whose qualifications, experience, and cultural beliefs align with the specific needs of the hiring organization. This volume, while a testament to a platform's popularity, can increase the effort required to sift through the multitude of profiles to find suitable candidates.

Second, the quality of profiles can vary significantly. While some candidates meticulously craft comprehensive and accurate resumes, others frequently provide incomplete, exaggerated and/or outdated information. This inconsistency in data quality can lead to misjudgments about a candidate's qualifications and suitability for a particular role.

Keyword-based searches, often relied upon for candidate filtering, constitute another hurdle. These searches can inadvertently omit qualified individuals who use different terminology or phrasing in their resumes. Additionally, the limited context provided by resumes can make it challenging to accurately assess a candidate's soft skills, work style, or cultural fit.

Furthermore, the competitive nature of career sites exacerbates these difficulties. The competitive nature of career sites means that top-tier talent is often actively pursued by numerous employers, making it challenging for recruiters and hiring companies to secure the interest and commitment of top-tier talent. A single job posting can attract a multitude of applications, intensifying the competition for talent and making it harder to identify and engage with suitable candidates.

Thus, the task of finding the perfect candidates on career websites is undoubtedly a herculean one. The sheer volume, variable data quality, reliance on keywords, limited context, and intense competition collectively contribute to the perception that identifying a suitable candidate amidst this digital haystack is a dauting and time-consuming feat. Thus, recruiters need to employ innovative strategies, leverage technology, and exercise due diligence to navigate these challenges effectively and identify the best-matched candidates for their organizations with speed and accuracy. Existing individual/existing systems simply do not allow for efficient searching to identify quality candidates.

The right candidate search with speed and accuracy can be far too widespread and can be far too important to be constrained by the above-described limitations and/or constraints. The companies, individual recruiters, groups of recruiters/individuals, individuals, or freelancers would be better served by a system which overcomes the shortcomings of the prior art.

The world of recruitment has long been characterized by its reliance on a vast network of professional relationships, coupled with the accumulation of extensive candidate databases. Experienced companies, individual recruiter, a group of recruiters/individuals, individual, or freelancer, whether operating independently or within recruitment agencies, have built treasure troves of candidate resumes and invaluable insights over their careers. These databases are a testament to their expertise and dedication, encompassing resumes, notes on candidate interactions, skill assessments, and career histories. This wealth of knowledge remains locked within private individual/group recruiters databases, awaiting untapped potential.

There is untapped potential of this vast knowledge repository. A platform that could facilitate the sharing of candidate data companies, individual recruiter, a group of recruiters/individuals, individual, or freelancer. Such a platform would have the potential to revolutionize the recruitment industry by creating a vast, interconnected network of shared candidate profiles. The foundation of this innovation lies in the idea that if recruiters could share their candidate's data, they would collectively gain access to a much broader and more diverse pool of pre-qualified talent.

What is needed is a system and method for exchange of resumes capable of providing efficient gathering of batches of resumes/talent profiles/biodata from single private collections on single computers which facilitates information sharing/exchange or rental across a network of multiple private computers in one to one or one to many fashion. That is, a system, apparatus and method for providing resumes/talent profiles/biodata access and organization services in terms of skill sets and contact information for effectuating services and activities involving and/or related to talent profile access and/or search by, and/or for, entities, individual recruiters, groups of recruiters/individuals, individuals, or freelancers and a system and method of providing services which facilitate entities, individual recruiters, groups of recruiters/individuals, individuals, or freelancers in sharing talent profiles from their private collection among themselves and which can provide a centralized apparatus, and/or a clearinghouse, for providing and/or for facilitating the herein-described efforts, services, and/or activities.

### SUMMARY

The present disclosure relates to a system and method designed to enable the efficient gathering of batches of resumes/talent profiles/biodata from a single collection and or multiple private collections from a single computer processor and/or a group of computer processors and their sharing or rental across a network of multiple private computer processors in one end point to one end point or one end point to many end point fashions. The system and apparatus can streamline the process of gathering batches of resumes/talent profiles/Biodata from a single collection and or multiple collections from a single computer processor and or group of computer processors and their standardized formatting and facilitates seamless sharing and/or renting on temporary/permanent basis of resumes/talent profiles/biodata among computer processors in private one to one and/or one-to-many computer processors fashion, enhancing accessibility and collaboration in a digital environment. The system, method and apparatus can increase accessibility of talent pools across participating computer processors used by various entities, individual recruiter, a group of recruiters/individuals, individual, or freelancer through collaboration.

Disclosed is a system, apparatus and method for providing efficient gathering of batches/group of resumes/talent profiles/biodata from private single source and/or a group of multiple sources clubbed into one where this single source and/or a group of multiple sources clubbed into one share these from its private collection, standardizing and sharing and/or renting on temporary/permanent basis across a network of multiple private computer processors in point processor to point processor sharing and/or point processor to multiple point processors including a memory (ROM and/or RAM, which can be one or more blocks or groups of memory), group of memories, storage devices connected through network connections, interactions with other devices which stores multiple resumes/talent profiles/Biodatas, for a company, individual recruiter, a group of recruiters/individuals, individual, Talent Acquisition Specialist, Sourcing Specialist, Technical Sourcer, Talent Scout or freelancer to an individual processor or processors working in a group.

The system, method and apparatus can provide efficient talent profile access and/or search activities. The system, method and apparatus can utilize the technologies and advances in information technology and in communication technology to provide these services in a network environment through mutual collaboration.

An advantage of the system, method and apparatus is the concept of mutual benefit. Experienced recruiters understand that by opening up their databases to others, they can not only gain financial advantages but also enhance their ability to reach out to the right fit candidate with speed. In essence, this system, method and apparatus creates a win-win scenario for companies, individual recruiter, a group of recruiters/individuals, individual, or freelancer. They can monetize their knowledge by allowing other recruiters to access their database, and in return, they gain access to a broader spectrum of potential candidates from their peers' databases.

The disclosed resume database exchange network sets itself apart from conventional career search sites in several keyways. First, in these networks, batches/group of resumes/talent profiles/biodata are not Job seeker submitted but are sourced by participating recruiters, ensuring a higher quality of candidates. The profiles can be privately owned by the recruiter, not the job seeker.

Second, the focus is on candidates, individuals who aren't actively job-hunting but are open to new opportunities, making for a unique talent pool.

Third, these networks emphasize the curation of up-to-date information by recruiters, ensuring that candidate profiles accurately reflect their qualifications and preferences. Multiple Companies/recruiters/Talent Acquisition Specialist/Sourcing Specialist/Technical Sourcer/Talent Scout can submit the same profile, provided that each independently acquired it and have made updates exclusive to their acquisition. The disclosed system, method and apparatus provides a more targeted and effective system, method and apparatus for matching candidates with specific needs, setting them apart from traditional career sites.

By enabling a network of recruiters to collaborate, each participant brings a unique set of profiles they have encountered in the course of their recruitment endeavors. These profiles represent a wealth of knowledge and insights, making them valuable assets in the talent acquisition landscape. When a recruiter, for example Recruiter A, shares a profile within the network, these profile summaries become accessible only to fellow participating recruiters (ranging from 0 to N). This exclusivity ensures privacy and confidentiality within the network.

Any recruiter within the network, denoted as Recruiter B (with B ranging from 0 to N), has the ability to request full access to any of the profiles shared by Recruiter A. The sharing arrangement can take two primary forms: permanency for the entire lifetime of the network or temporarily for a specified duration. The basis for these sharing arrangements can be either a barter system or compensation-based system.

In a barter scenario, when a requesting recruiter, by way of non-limiting example, Recruiter B, desires access to a profile shared by Recruiter A, they can reciprocate by sharing profiles from their own collection of public profiles. This mutual exchange enriches the database and fosters collaboration among recruiters. It can be a symbiotic relationship where participants benefit from each other's expertise.

In some embodiments, the requesting recruiter can compensate the first recruiter using predefined monetary terms for access to the shared profile. This compensatory exchange embodies the value of the shared knowledge and expertise. It's a fair and transparent way to reward the recruiter who originally brought the profile into the network.

To ensure the credibility and trustworthiness of both the recruiter and the shared profile, a rating system can be implemented. Recruiters within the network can rate each other based on their professionalism, reliability, and the quality of the shared profiles. Similarly, the shared profiles can be rated based on their relevance and accuracy. In some embodiments, ratings can be criteria for determining the desirability of a recruiter or profile within the network.

In some embodiments, the same profile can be submitted and shared by multiple recruiters, provided that each recruiter independently acquired the profile and has made updates to it. This collaborative approach acknowledges that different recruiters can interact with a candidate at various stages of their career, and their collective insights enhance the profile's accuracy and completeness.

As recruiters gain credibility and positive ratings, their resumes can become more highly valued within the network, attracting more requests for their profiles. This increased desirability can lead to financial compensation, creating a dynamic ecosystem where expertise and knowledge are not only valued but also compensated.

The disclosed system, method and apparatus can network improve the recruitment landscape by transforming it into a collaborative, knowledge-sharing community where recruiters and profiles alike benefit from their participation. It can incentivize recruiters to source and share valuable profiles and also to maintain the highest standards of professionalism and expertise, ultimately enhancing the quality of talent acquisition in the network.

A system of one or more computers can be configured to perform particular operations or actions by virtue of having software, firmware, hardware, or a combination of them installed on the system that, in operation, causes or cause the system to perform the actions. One or more computer programs can be configured to perform particular operations or actions by virtue of including instructions that, when executed by data processing apparatus, cause the apparatus to perform the actions.

In one general aspect, a method can comprise receiving into memory information associated with a first candidate. The method can also include storing in a first database said information associated with said first candidate. The method can furthermore include enabling access to said information associated with said first candidate by a first user profile. The method can, in addition, include extracting abstract data from said information associated with said first candidate to identify extracted abstract data. The method can moreover include storing in a second database said extracted abstract data. The method can also include associating said extracted abstract data with said first user profile. The method can furthermore include associating said extracted abstract data with a first token value. The method can, in addition, include determining whether said extracted abstract data is authorized for publication. The method can moreover include publishing said extracted abstract data to a publicly searchable database if said extracted abstract data is authorized for publication. The method can also include receiving a request from a second user profile to transfer information associated with said first candidate. The method can furthermore include receiving said first token value to said first user profile. The method can, in addition, include, in response to receipt of said first token value to said first user profile, transferring said information associated with said first candidate to said second user profile. Other embodiments of this aspect include corresponding computer systems, apparatus, and computer programs recorded on one or more computer storage devices, each configured to perform the actions of the methods.

Implementations can comprise one or more of the following features. The method can comprise, in response to receipt of said first token value to said first user profile, deleting said extracted abstract data from said publicly searchable database. The method can comprise, in response to receipt of said first token value to said first user profile, disassociating said extracted abstract data with said first user profile. The method can comprise, in response to receipt of said first token value to said first user profile, associating said extracted abstract data with said second user profile. The method can comprise, in response to receipt of said first token value to said first user profile, disabling access to said information associated with said first candidate by said first user profile. The method can comprise, in response to receipt of said first token value to said first user profile, enabling access to said information associated with said first candidate by said second user profile. The method where said token value is based at least in part on said extracted data. The method where a prescribed lease period is associated with said first token value. The method can comprise, in response to receipt of said first token value to said first user profile, temporarily disassociating said extracted abstract data with said first user profile for said prescribed lease period. The method can comprise, in response to receipt of said first token value to said first user profile, temporarily associating said extracted abstract data with said second user profile for said prescribed lease period. The method can comprise, in response to the conclusion of said prescribed lease period, automatically disassociating said extracted abstract data with said second user profile. The method can comprise, in response to receipt of said first token value to said first user profile, temporarily disabling access to said information associated with said first candidate by said first user profile for said prescribed lease period. The method can comprise, in response to receipt of said first token value to said first user profile, temporarily enabling access to said information associated with said first candidate by said second user profile for said prescribed lease period. The method can comprise, in response to the conclusion of said prescribed lease period, automatically disabling access to said information associated with said first candidate by said second user profile. The method where said token value is based at least in part on said prescribed lease period. The method where said token value is based at least in part on said extracted data. Implementations of the described techniques can comprise hardware, a method or process, or a computer tangible medium.

In one general aspect, a device can comprise one or more processors configured to. The device can also include receiving into memory information associated with a first candidate. The device can furthermore include storing in a first database said information associated with said first candidate. The device can, in addition, include enabling access to said information associated with said first candidate by a first user profile. The device can moreover include extracting abstract data from said information associated with said first candidate to identify extracted abstract data. The device can also include storing in a second database said extracted abstract data. The device can furthermore include associating said extracted abstract data with said first user profile. The device can, in addition, include associating said extracted abstract data with a first token value. The device can moreover include determining whether said extracted abstract data is authorized for publication. The device can also include publishing said extracted abstract data to a publicly searchable database if said extracted abstract data is authorized for publication. The device can furthermore include receiving a request from a second user profile to transfer information associated with said first candidate. The device can, in addition, include receiving said first token value to said first user profile. The device can moreover include, in response to receipt of said first token value to said first user profile, transferring said information associated with said first candidate to said second user profile. Other embodiments of this aspect include corresponding computer systems, apparatus, and computer programs recorded on one or more computer storage devices, each configured to perform the actions of the methods.

Implementations can comprise one or more of the following features. The device where the one or more processors are further configured to, in response to receipt of said first token value to said first user profile, delete said extracted abstract data from said publicly searchable database. The device where the one or more processors are further configured to, in response to receipt of said first token value to said first user profile, disassociate said extracted abstract data with said first user profile. The device where the one or more processors are further configured to, in response to receipt of said first token value to said first user profile, associate said extracted abstract data with said second user profile. The device where the one or more processors are further configured to, in response to receipt of said first token value to said first user profile, disable access to said information associated with said first candidate by said first user profile. The device where the one or more processors are further configured to, in response to receipt of said first token value to said first user profile, enable access to said information associated with said first candidate by said second user profile. The device where said token value is based at least in part on said extracted data. The device where a prescribed lease period is associated with said first token value. The device where the one or more processors are further configured to, in response to receipt of said first token value to said first user profile, temporarily disassociate said extracted abstract data with said first user profile for said prescribed lease period. The device where the one or more processors are further configured to, in response to receipt of said first token value to said first user profile, temporarily associate said extracted abstract data with said second user profile for said prescribed lease period. The device where the one or more processors are further configured to, in response to the conclusion of said prescribed lease period, automatically disassociate said extracted abstract data with said second user profile. The device where the one or more processors are further configured to, in response to receipt of said first token value to said first user profile, temporarily disable access to said information associated with said first candidate by said first user profile for said prescribed lease period. The device where the one or more processors are further configured to, in response to receipt of said first token value to said first user profile, temporarily enable access to said information associated with said first candidate by said second user profile for said prescribed lease period. The device where the one or more processors are further configured to, in response to the conclusion of said prescribed lease period, automatically disable access to said information associated with said first candidate by said second user profile. The device where said token value is based at least in part on said prescribed lease period. The device where said token value is based at least in part on said extracted data. Implementations of the described techniques can comprise hardware, a method or process, or a computer tangible medium.

In one general aspect, a system can comprise one or more processors configured to perform a plurality of steps. The system can also include receiving into memory information associated with a first candidate. The system can furthermore include storing in a first database said information associated with said first candidate. The system can, in addition, include enabling access to said information associated with said first candidate by a first user profile. The system can moreover include extracting abstract data from said information associated with said first candidate to identify extracted abstract data. The system can also include storing in a second database said extracted abstract data. The system can furthermore include associating said extracted abstract data with said first user profile. The system can, in addition, include associating said extracted abstract data with a first token value. The system can moreover include determining whether said extracted abstract data is authorized for publication. The system can also include publishing said extracted abstract data to a publicly searchable database if said extracted abstract data is authorized for publication. The system can furthermore include receiving a request from a second user profile to transfer information associated with said first candidate. The system can, in addition, include receiving said first token value to said first user profile. The system can moreover include, in response to receipt of said first token value to said first user profile, transferring said information associated with said first candidate to said second user profile. Other embodiments of this aspect include corresponding computer systems, apparatus, and computer programs recorded on one or more computer storage devices, each configured to perform the actions of the methods.

Implementations can comprise one or more of the following features: The system where the one or more processors are further configured to, in response to receipt of said first token value to said first user profile, delete said extracted abstract data from said publicly searchable database. The system where the one or more processors are further configured to, in response to receipt of said first token value to said first user profile, disassociate said extracted abstract data with said first user profile. The system where the one or more processors are further configured to, in response to receipt of said first token value to said first user profile, associate said extracted abstract data with said second user profile. The system where the one or more processors are further configured to, in response to receipt of said first token value to said first user profile, disable access to said information associated with said first candidate by said first user profile. The system where the one or more processors are further configured to, in response to receipt of said first token value to said first user profile, enable access to said information associated with said first candidate by said second user profile. The system where said token value is based at least in part on said extracted data. The system where a prescribed lease period is associated with said first token value. The system where the one or more processors are further configured to, in response to receipt of said first token value to said first user profile, temporarily disassociate said extracted abstract data with said first user profile for said prescribed lease period. The system where the one or more processors are further configured to, in response to receipt of said first token value to said first user profile, temporarily associate said extracted abstract data with said second user profile for said prescribed lease period. The system where the one or more processors are further configured to, in response to the conclusion of said prescribed lease period, automatically disassociate said extracted abstract data with said second user profile. The system where the one or more processors are further configured to, in response to receipt of said first token value to said first user profile, temporarily disable access to said information associated with said first candidate by said first user profile for said prescribed lease period. The system where the one or more processors are further configured to, in response to receipt of said first token value to said first user profile, temporarily enable access to said information associated with said first candidate by said second user profile for said prescribed lease period. The system where the one or more processors are further configured to, in response to the conclusion of said prescribed lease period, automatically disable access to said information associated with said first candidate by said second user profile. The system where said token value is based at least in part on said prescribed lease period. The system where said token value is based at least in part on said extracted data. Implementations of the described techniques can comprise hardware, a method or process, or a computer tangible medium.

The preceding summary is presented to assist with understanding the of the disclosure and is neither an exhaustive nor an exclusive summary. This summary is not representative of all of the embodiments defined by the claims and should not be considered limitations of the claims, or limitations on equivalents to the claims. Thus, this summary should not be considered dispositive when determining equivalence. Additional features and advantages will become apparent from a review of the detailed description, figures, and claims.

### BRIEF DESCRIPTION OF THE DRAWINGS

Further details of the present device are explained with the help of the attached drawings in which:

FIG. 1 depicts a high-level overview of an embodiment of a system and apparatus for exchange of resumes, in block diagram form.

FIGS. 2A-2B depict an embodiment of a system and apparatus for exchange of resumes, in block diagram form.

FIG. 3 depicts an embodiment of a server computer in block diagram form.

FIG. 4 depicts an embodiment of a single computer processor in block diagram form.

FIG. 6 depicts an embodiment of a plurality of single computer processors in block diagram form.

FIG. 6 depicts an embodiment of a function block diagram of the instantiation process.

FIG. 7 depicts an embodiment of a function block diagram of the acquisition process.

FIGS. 8A-8B depict an embodiment of a function block diagram of operation of the system apparatus depicted in FIGS. 1-2B as utilized for a purchase.

FIG. 9A-9B depict an alternate embodiment of a function block diagram of operation of the system and apparatus depicted in FIGS. 1-2B as utilized for a rental.

FIGS. 10A-10E depict an embodiment of a function block diagram of operation of the system and apparatus depicted in FIGS. 1-2B.

FIG. 11 depicts a diagram of an example environment in which systems and/or methods described herein can be implemented.

FIG. 12 depicts an embodiment of a functional flow block diagram for exchange of tokens.

FIG. 13 depicts an embodiment of a functional flow block diagram for upload of items to the system.

FIG. 14 depicts an embodiment of a functional flow block diagram for exchange of items within the system.

FIG. 15 depicts an embodiment of a functional flow block diagram for exchange of tokens within the system.

FIG. 16 depicts an embodiment of a functional flow block diagram for exchange of tokens within the system 1600.

FIG. 17 depicts an embodiment of a computer network system.

### DETAILED DESCRIPTION

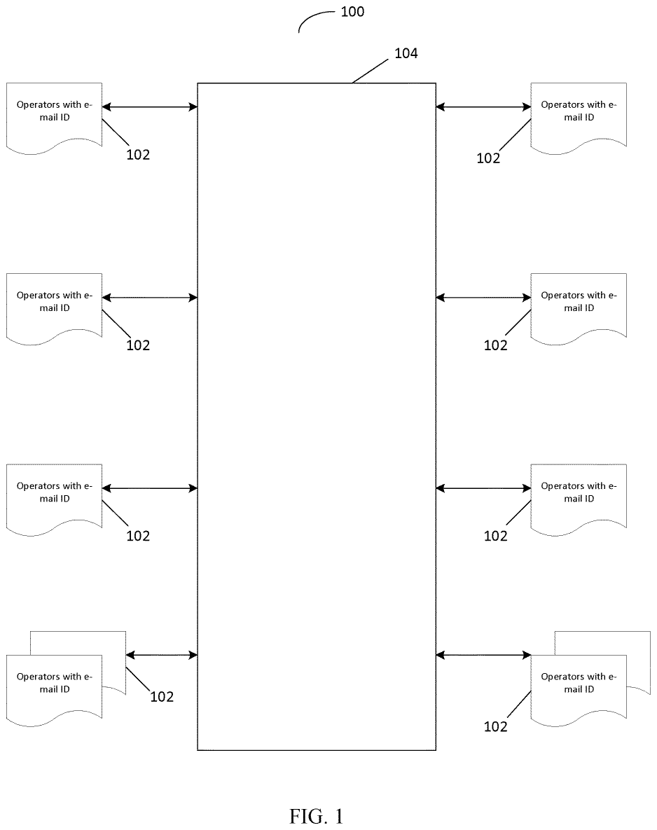

FIG. 1 depicts a high-level overview of an embodiment of a system and apparatus for exchange of resumes 100, in block diagram form. In the embodiment depicted in FIG. 1, a plurality of individual operators 102 can be in electronic communication with a host server computer 104. In some embodiments each individual operator 102 can be associated with a unique e-mail address. However, in alternate embodiments, individual operators can be associated with any known, convenient and/or desired unique identifier which can be user-selected and/or assigned automatically by the system 100. Electronic communication between each individual operator 102 and the host server computer 104 can be accomplished via any known, convenient and/or desired electronic communication mechanism now known or later developed which enables unilateral and/or bilateral exchange of information between computing devices.

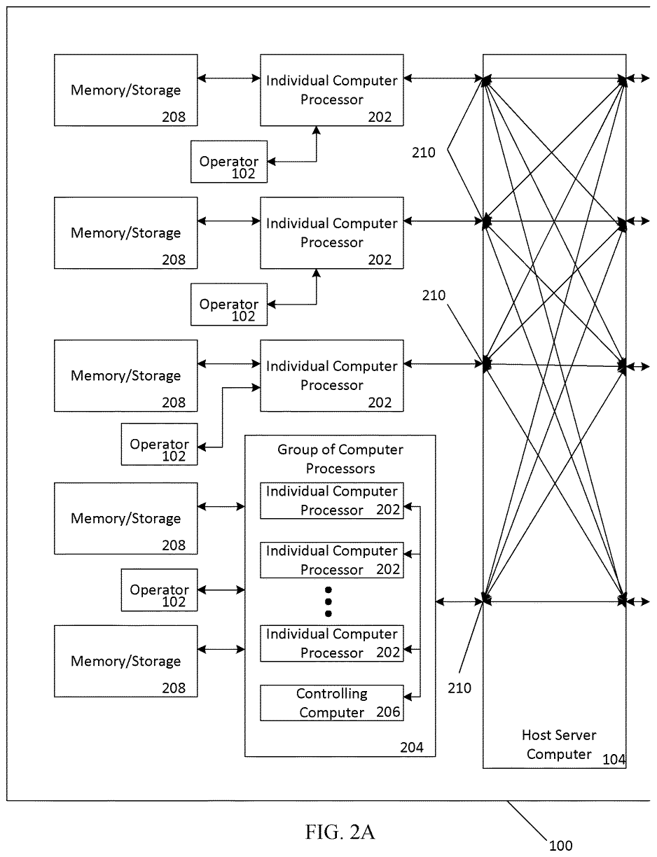

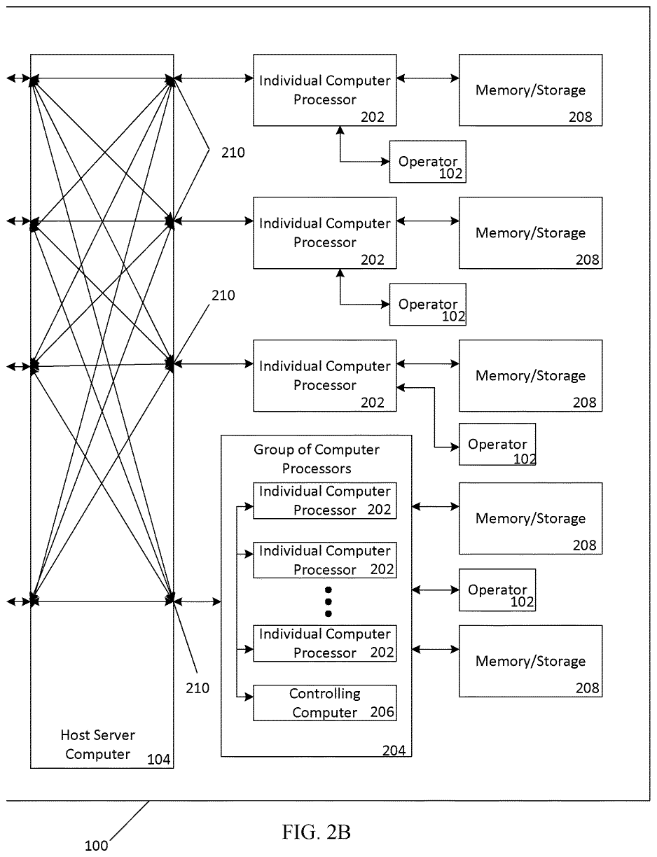

FIGS. 2A-2B depict an embodiment of a system and apparatus for exchange of resumes 100, in block diagram form. As depicted in FIGS. 2A-2B, the system and apparatus 100 can comprise a host server computer 104. In some embodiments, the host server computer 104 can provide end point data sharing services for various single or group processor(s) 202 which can be employed by various entities, such as, by way of non-limiting example, individual recruiters, a group of recruiters/individuals, individuals, or freelancers who or which can interact with the system and apparatus 100.

In some embodiments, any number of host server computers 104 can be utilized to provide the functions as described herein. In some embodiments, one or more host server computers 104 can be in electronic communication with other host server computers 104 or, in alternate embodiments, the system and apparatus 100 can operate as one or more standalone devices. In some embodiments, host server computer 104 can provide service to a particular geographic area, certain entities, an individual recruiter, individual recruiters, a group of recruiters/individuals, individuals, one or more freelancers and/or any other known convenient and/or desired individual, group, organization or interface. In some embodiments, one or more host server computers 104 can service any one or more groups of the above-described individuals and/or entities.

In the embodiment depicted in FIGS. 2A-2B, one or more individual computer processors 202 and/or one or more groups of computer processors 204 utilized by the various entities and/or individual recruiter and/or a group of recruiters/individuals, and/or individuals, and/or freelancer can store and/or retrieve information from storage device(s) 208 which can be memory (ROM and RAM), group of memories, storage devices connected through network connections and/or interactions with other devices capable of storage individually or in combination with one or more other storage devices 208, wherein a controlling computer 206 can at least partially control other computer processers 202 within said one or more groups of computer processors 204.

In some embodiments, apparatus 100 can also include one or more single computer processor 202 and/or one or more group of computers processors 204 used by the various entities and/or individual recruiter and/or a group of recruiters/individuals, and/or individuals, and/or freelancers, referred to hereinafter as operators 102. Operators 102 can be sellers and/or buyers/renters and such can be designated based on the role played at the time/instant of a transaction and can, in some embodiments be, buyer/renter operators 102 and/or seller operators 102. Each single computer processor 202 can be a personal computer or other communication device suitable for allowing the various entities and/or individual recruiter and/or a group of recruiters/individuals, and/or individuals, and/or freelancers to interact with each other through one or more host server computer(s) 104. In some embodiments, one or more group of computers processors 204 can be a group of personal computer or other communication device suitable for allowing the various entities and/or individual recruiters and/or a group of recruiters/individuals, and/or individuals, and/or freelancers associated with the group to interact with each other through the host server computer(s) 104.

In some embodiments, one or more single computer processor 202 and/or one or more group of computer processors 204 can be utilized to transmit information to the host server computer(s) 104 and receive information from the host server computer(s) 104 via a communication network via one or more nodes 210. In some embodiments, any number of single computer processors 202 and/or one or more group of computer processors 204 can be employed.

In some embodiments, single computer processor 202 can be a transmitter of information to the other one or more single computer processor 202 and/or one/or more group of computers processors 204 through host server computer(s) 104 directly or indirectly and/or a receiver of information from one or more single computer processors 202 and/or one or more group of computer processors 204 through host server computer(s) 104 directly or indirectly. In some alternate embodiments, one or more groups of computer processors 204 can be a transmitter of information to the other one or more single computer processors 202 and/or one or more groups of computer processors 204 through host server compute(s) 104 directly or indirectly and/or a receiver of information from one or more single computer processors 202 and/or one or more groups of computer processors 204 through host server computer(s) 104 directly or indirectly.

In the embodiment depicted in FIGS. 2A-2B, the host server computer(s) 104, the one or more single computer processors 202 and/or one or more groups of computer processors 204 can communicate with one another, and/or be linked to one another, via a direct or indirect and connected and/or wireless communications network. In some embodiments, the system, method and apparatus can be utilized on and/or utilized with, and/or over, the internet and/or configured to communicate via or interact with the world wide web. The host server computer(s) 104, in some embodiments, can have a web site or web sites associated therewith. In some embodiments, each of the host server computer(s) 104, one or more single computer processors 202 and/or one or more groups of computer processors 204 can transmit data and/or information using TCP/IP, any other Internet and/or World Wide Web protocols and/or any other now known or future developed, direct or indirect communication protocols.

In the embodiment depicted in FIGS. 2A-2B, the one or more single computer processors 202 and/or one or more groups of computer processors 204 can be linked directly or indirectly with the host server computer(s) 104. In some embodiments, any one or more single computer processors 202 and/or one or more group of computer processors 204 can be linked directly or indirectly with any one or more single computer processors 202 and/or one or more group of computer processors 204 through the host server computer(s) 104 to enable direct or indirect bi-directional communication between such devices.

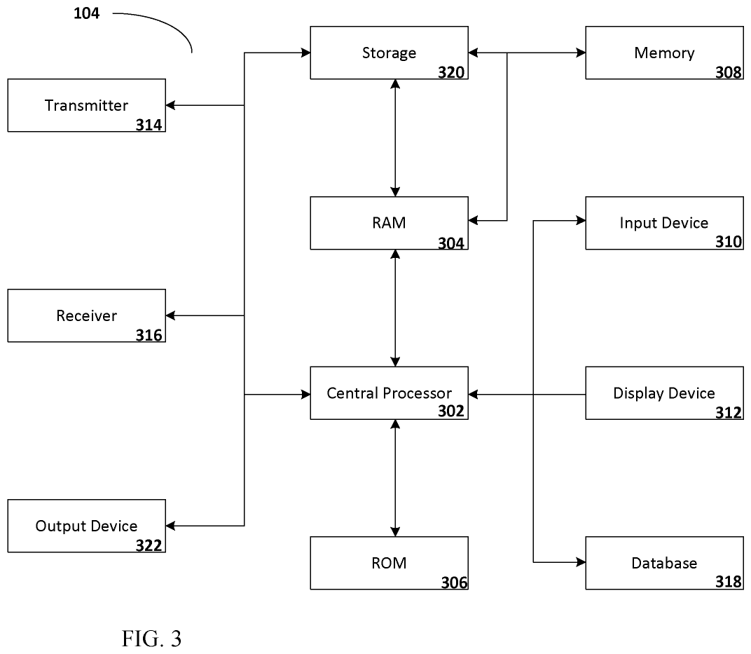

FIG. 3 depicts an embodiment of a host server computer 104 in block diagram form. In some embodiments, the host server computer 104 can be a network computer or computer system employed as a host server, enabling services such as, but not limited to, functioning as an internet server computer and/or a web site server computer.

In the embodiment depicted in FIG. 3, the host server computer 104 can incorporate a central processor 302, which, in some embodiments, can be a microprocessor. However, in alternate embodiments, the host server computer 104 can employ any known, convenient and/or desired processor. When employed in some applications, the central processor 302 can be a microcomputer, a minicomputer, a macro-computer, a mainframe computer and/or any other known, convenient and/or desired device adapted and configured to perform programmable processing and/or control functions.

In the embodiment depicted in FIG. 3, the host server computer 104 can be equipped with random-access memory device(s) (RAM) 304 and/or read-only memory device(s) (ROM) 306 and Memory 308 which can be in direct or indirect electronic communication with the central processor 302. In some embodiments, one or more user input devices 310 can enable data and command input to the host server computer 104. In various embodiments, the user input devices 310 can comprise a keyboard, a scanner, a user pointing device like a mouse or touchpad and/or any other known, convenient and/or desired device adapted to provide user input to the host server computer 104. Additionally, in some embodiments, the host server computer 104 can comprise a display device 312 adapted and configured to present data and/or information to a user or operator.

In the embodiment depicted in FIG. 3, the host server computer 104 can comprise a one or more transmitter(s) 314 configured to send signals, data, and/or information to one or more individual computer processors 202 or one or more groups of computer processors 204. In some embodiments, the host server computer 104 can comprise a receiver 316 for receiving signals, data, and/or information from one or more individual computer processors 202 or one or more groups of computer processors 204.

In the embodiment depicted in FIG. 3, the host server computer 104 can comprise one or more database(s) 318 which can be centralized or distributed and which can contain data and/or information related to one or more of the various entities and/or individual recruiter and/or a group of recruiters/individuals, and/or individuals, and/or freelancers, who or which interact with the system 100 to share/rent batches of resumes/talent profiles/biodata from a single collection and/or multiple collections from a single computer processor 202 and/or a group of computer processors 204.

Batches of resumes/talent profiles/biodata can be uploaded one by one or in batches at the same time or at different times by the entities and/or individual recruiter and/or a group of recruiters/individuals, and/or individual, and/or freelancer. Batches of resumes/talent profiles/biodata considered as data and/or information can be stored in database(s) 318. Batches of resumes/talent profiles/biodata can be stored in the database(s) 318 as a link to Storage 320 or can be directly stored into the database(s) 318. Processing of the Batches of resumes/talent profiles/biodata can be performed via one or more centralized in the Host Server computer(s) 104 and/or distributed between one or more individual computer processors 202 where such can be uploaded from or one or more groups of computer processors 204 where such can be uploaded from and the Host Server computer(s) 104.

By way of non-limiting example, data and/or information, which can be stored in the database(s) 318 can comprise resumes/talent profiles/biodata with identification such as name, email id and phone number in the resumes/talent profiles/biodata long with ownership id of the entities and/or individual recruiter and/or a group of recruiters/individuals, and/or individual, and/or freelancer who uploaded the resumes/talent profiles/biodata one by one or in batches at the same time or at different times. In some embodiments, resumes/talent profiles/biodata and/or similar data can be uploaded and can be associated with unique profile ids in combination with unique ownership id of the entities and/or individual recruiter and/or a group of recruiters/individuals, and/or individual, and/or freelancer who uploaded the resumes/talent profiles/biodata one by one or in batches at the same time or at different times.

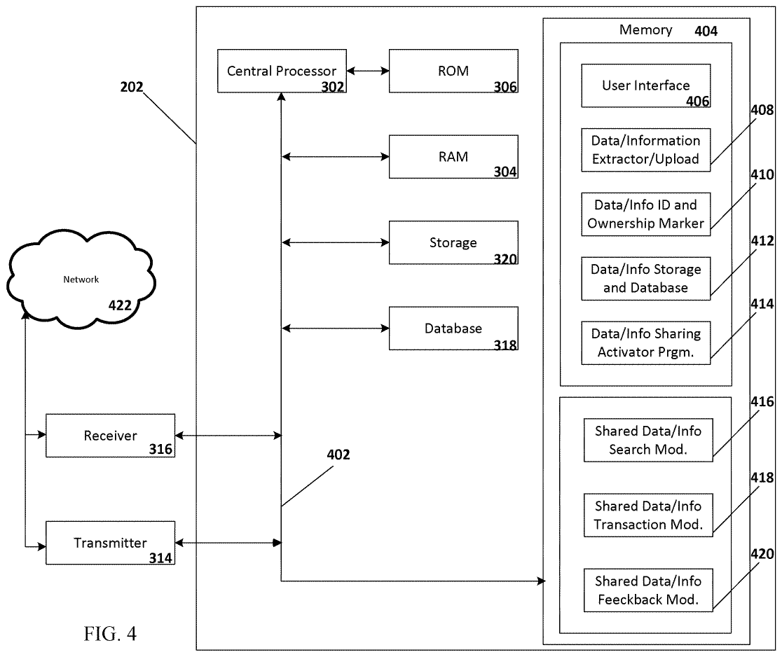

FIG. 4 depicts an embodiment of a single computer processor 202 in block diagram form. The single computer processor 202 can be a network computer or computer system which can be utilized to access and/or to communicate with the Host Server computer 104. In some embodiments, the single computer processor 202 can comprise a central processing unit or CPU 302, which can, in some embodiments, be a microprocessor. In some embodiments, CPU 302 can be a microcomputer, a minicomputer, a macro-computer, and/or a mainframe computer, and/or any other known convenient and/or desired processing apparatus depending upon the application.

In some embodiments, the single computer processor 202 can comprise random access memory device(s) 304 (RAM) and a read only memory device(s) 306 (ROM), each of which can be in electronic communication with the CPU 302, a user input device 310, for entering data and/or commands into the single computer processor 202, which can comprise any one or more of a keyboard, a scanner, a user pointing device, such as, for example, a mouse, a touch pad, and/or an audio input device and/or a video input device, as desired, which input device(s) can also be in electronic communication with the CPU 302. The single computer processor 202 can be in electronic communication with a display device 312 adapted and/or configured to display data and/or information to a user or operator 102.

The single computer processor 202 can comprise a transmitter(s) 314, for transmitting signals and/or data and/or information to the other one or more single computer processor 202 and/or one/or more group of computers processors 204 through Host Server computer(s) 104 directly or indirectly. The single computer processor 202 can comprise a receiver 316, adapted and/or configured to receive signals and/or data and/or information from one or more single computer processor 202 and/or one/or more groups of computers processors 204 through Host Server computer(s) 104 directly or indirectly.

In some embodiments, the single computer processor 202 can be in electronic communication with one or more Storage Groups 208 consisting of one or more of memories (ROM and RAM), group of memories, storage devices in electronic communication via network connections, interactions with other devices capable of Storage which can contain any and/or all of the data and/or information described herein regarding database(s) 318 connected with the Host Server computer(s) 104.

FIG. 4 depicts a host computer processor memory configuration in block diagram form. In the embodiment depicted in FIG. 4, database 318 and storage 320 are depicted as separate devices. However, in some embodiments database 318 and storage 320 can be a single physical device which can comprise a separate logical partition for database 318 and storage 320 and/or be unpartitioned. FIG. 4 further depicts database 318 and storage 320 as internal devices. However, in alternate embodiments these devices can each be external to host server computer(s) 104 and in electronic communication via one or more network connections. In some embodiments, host server computer(s) 104 can be implemented on a distributed database 318 over multiple storage devices to suit efficiency, performance, backup, and data warehousing requirements and/or desires.

In one embodiment in FIG. 4, the configuration of memory 404 comprises user a interface 406, data and/or information extractor/uploader 408, data and/or information ID and ownership marker 410, data and/or information storage and database 412, a data and/or information sharing activator program 414, a search module for searching shared data and/or information 416, a shared data and/or information transaction module 418, and a shared data and/or information feedback module 420.

These enabled modules can store intermediate results in memory 404 and transmit results via bus 402 for storage in database 318 and/or storage 420. In alternate embodiments the configuration of memory 404 may not incorporate all such modules. In the embodiment depicted in FIG. 4, central processor 302 coordinates loading a program when desired, storing intermediate results, transferring data from one program to another, and unloading the program when such is no longer desired.

User interface 406, data and/or information extractor/uploader 408, data and/or information ID and ownership marking 410, data and/or information storage and database 412, data and/or information sharing activator program 414, search module for shared data and/or information 416, shared data and/or information transaction module 418, and shared data and/or information feedback module 420 can be web-based graphical user interface such as a hypertext markup language (HTML) web page that is accessible using a general-purpose hypertext transfer protocol (HTTP) web browser or can be standalone application program implemented using an interface tool such as Java ®, or Microsoft Visual Basic® and/or any other known, convenient and/or desired language.

In some embodiments, user interface 406 can be a web-based graphical user interface such as a hypertext markup language (HTML) web page that is accessible using a general-purpose hypertext transfer protocol (HTTP) web browser. In another embodiment, user interface program 406 is a standalone application program implemented using an interface tool such as Java ®, or Microsoft Visual Basic ® and/or any other known, convenient and/or desired language. In operation, entities can use, through individual recruiters and/or, multiple recruiters and/or individual recruiter and/or a group of recruiters/individuals, and/or individual, and/or freelancer operate user interface 406 to access data and/or information extractor/uploader 408, data and/or information ID and ownership marker 410, data and/or information storage and database 412, data and/or information sharing activator program 414, search program for shared data and/or information module 416, shared data and/or information transaction module 418, and shared data and/or information feedback module 420.

Data and/or information extractor/uploader 408 can be centralized in the Host Server computer 104 and/or can be distributed between Host Server computer 104 and computers processors 202 and/or one/or more group of computers processors 204.

In some embodiments, an input to the data and/or information extractor/uploader 408 can be a talent profile/resume/biodata called data and/or information in an electronic format. Electronic formats can encompass a wide array of mediums for storing and transmitting information, ranging from email messages with or without attachments to various types of computer files which can play a role in organizing and preserving textual data. Specifically, computer files that store text can come in formats such as but not limited to Word documents, rich text format (RTF) files, text file portable document format (PDF®) files, and Excel® spreadsheets.

Data and/or information can be processed in computers processors 202 and/or one/or more groups of computers processors 204 and/or in host server computer 104. In some embodiments data and/or information extractor/uploader 408 can be distributed between computers processors 202 and/or one/or more group of computers processors 204 and/or a host server computer 104 for extracting targeted data from a computer processor(s) 202 and/or one/or more group of computers processors 204 repository or files and transferring it efficiently to the Host Server computer 104. In some embodiments, the system can be adapted and/or configured to enhance data retrieval operations by leveraging the resources and capabilities of both the computers processor(s) 202 and/or one/or more group of computers processors 204 and the host server computer 104 environments.

In embodiments comprising a distributed computing system, the computers processor(s) 202 and/or one/or more groups of computers processors 204 and the data and/or information extractor/uploader 408 module of the program can function as the interface through which users interact with the extraction process, providing input regarding the specific data to be retrieved and the desired extraction criteria which will be provided by the host server computer(s) 104 module for supporting data and extraction instructions. Computers processor(s) 202 and/or one/or more groups of computers processors 204 and the data and/or information in file/files can be processed in batches or individually. In such embodiments, extraction criteria can extract the name, email, phone number, companies worked in, locations worked, Work Visa status, security clearance status, technologies worked and/or any other know, convenient and/or desired information in/from the Data and/or information submitted. The original computer files submitted can be converted to HTML format without changing its original format and text layout and extracted data from data and/or information and the file/files with HTML format associated with it can be named.

In operation, in some embodiments, data extracted from data and/or information received and/or the file/files with HTML format associated with it can be identified by the extracted email id in the data and/or other information in the file/files and ownership id of the operator(s) 102 (various entities, individual recruiter, a group of recruiters/individuals, individual, or freelancer) of computers processors 202 and/or one/or more groups of computers processors 204 created from email id/Ids of the respective operator(s) 102 (various entities, individual recruiter, a group of recruiters/individuals, individual, or freelancer) of the computers processors 202 and/or one/or more groups of computers processors 204 by data and/or information ID and ownership marking module 410 in host server computer(s) 104.

In some embodiments, the extracted data from data and/or information and the file/files with HTML format associated with it can be named item and can be checked against previously transmitted/received data and/or information in file/files identified by the same ownership id and extracted email id in the data and/or information in the file/files.

If the extracted data from data and/or information and the file/files with HTML format associated with it indicate that no prior records that the computers processors 202 and/or one/or more groups of computers processors 204 ids created from email id/Ids of the respective operator/s 102 (various entities, individual recruiter, a group of recruiters/individuals, individual, or freelancer) of the computers processor(s) 202 and/or one/or more groups of computers processors 204 have submitted, it can be transmitted on to data and/or information ID and ownership module 410 in Host Server computer 104 for assignment of a new ID and ownership marker module 410. If the extracted data from data and/or information and the file/files with HTML format associated with it are associated with a prior record, such can be checked for updates against data stored in data and/or information storage and database 412 module in host server computer 104. If the new extracted data is updated from the data stored in data and/or information storage and database 412 module, extracted data from data and/or information and the file/files with HTML format associated with it will be stored/updated, otherwise it will be rejected.

The extracted data and the files with HTML format can be transmitted from computers processor(s) 202 and/or one/or more groups of computers processors 204 to host server computer 104 via the internet using any of the protocols namely Hypertext Transfer Protocol (HTTP) or its secure counterpart, HTTPS, or FTP (File Transfer Protocol) or SFTP (SSH File Transfer Protocol), or SCP (Secure Copy Protocol).

In some embodiments, data and/or information extractor/uploader 408 can be centralized into host server computer 104. Data and/or information from computers processor(s) 202 and/or one/or more groups of computers processors 204 can be transmitted from computers processor(s) 202 and/or one/or more groups of computers processors 204 to host server computer 104 via the Internet using any of the protocols namely Hypertext Transfer Protocol (HTTP) or its secure counterpart, HTTPS, or FTP (File Transfer Protocol) or SFTP (SSH File Transfer Protocol), or SCP (Secure Copy Protocol). Data and/or information extractor/uploader 408 module associated with host server computer 104 can be stored, based on extraction criteria extract the name, email, phone number, companies worked in, locations worked, work Visa status, security clearance, technologies worked in and rework the Data and/or information in the file into HTML format absent modification of its original format.

In some embodiments, extracted data from data and/or information and the file/files with HTML format associated with such can be identified by extracted email id in the data and/or information in the file/files and ownership id of the operator(s) 102 (various entities, individual recruiter, a group of recruiters/individuals, individual, or freelancer) of computers processor(s) 202 and/or one/or more groups of computers processors 204 created from email ID/IDs of the respective operator(s) 102 (various entities, individual recruiter, a group of recruiters/individuals, individual, or freelancer) of the computers processors 202 and/or one/or more groups of computers processors 204 by data and/or information ID and ownership marking module 410 associated with host server computer 104. The extracted data from Data and/or information and the file/files with HTML format associated with it can be checked against the previously transmitted Data and/or information in file/files identified by the same ownership id and extracted email id in the Data and/or information in the file/files.

If the extracted data from data and/or information and the file/files with HTML format associated with such have no prior record that the computers processor(s) 202 and/or one/or more groups of computers processors 204 IDs created from email ID/IDs of the respective operator(s) 102 (various entities, individual recruiter, a group of recruiters/individuals, individual, or freelancer) of the computers processor(s) 202 and/or one/or more groups of computers processors 204 have submitted, such can be transmitted on to data and/or information ID and ownership module 410 associated with host server computer 104 and be assigned new ID and ownership marking(s). If the extracted data from data and/or information and the file/files with HTML format associated with it called item are associated with an earlier record, such can be checked for updates against data stored in data and/or information Storage and database module 412 associated with the host server computer 104. If the new extracted data is updated from the data stored in data and/or information storage and database module 412, extracted data from data and/or information and the file/files with HTML format associated with it can be stored and versioned, otherwise it will be rejected. Each extracted data from data and/or information and the file/files with HTML format associated with it, either new or updated, can be associated with and earn specific token values to the uploading operator(s) 102 as determined by the platform. Data and/or information extractor/uploader 408 along with shared data and/or information transaction module 418 can maintain a running log of the total tokens held by each operator 102.

In some embodiments, data and/or information ID and ownership marking module 410 can be centralized on the host server computer 104. However, in alternate embodiment, distributed computing and storage environments can be employed. The data and/or information ID and ownership marking module 410 can support data and/or information extractor/uploader 408 and can assign transmitted data and/or information and the file/files with HTML format associated with it an ID and ownership marking and identifying the previously submitted Data and/or information and the file/files with HTML format associated with it for further processing in Data and/or information Extractor/Uploader module 408. Extracted data from Data and/or information and the file/files with HTML format associated with it can be identified by extracted email id in the Data and/or information in the file/files and ownership id of the operator(s) 102(s (various entities, individual recruiter, a group of recruiters/individuals, individual, or freelancer) of computers processors 202 and/or one/or more groups of computers processors 204 created from email ID/IDs of the respective operator(s) 102 (various entities, individual recruiter, a group of recruiters/individuals, individual, or freelancer) of the computers processors 202 and/or one/or more groups of computers processors 204.

Once the extracted data from Data and/or information and the file/files with HTML format associated with it is appropriately identified, verified, versioned and id marked through data and/or information ID and ownership marking module 410, the data and/or information extractor/uploader module 408 can transmit all or a desired portion of the gathered information, along with the HTML files and versioned data for previously submitted data from data and/or information and the file/files with HTML format associated with it to the next module: the data and/or information storage and Ddatabase 412. Data can be stored in a structured manner and pushed to either database 318 or storage 320, depending on the specific desire and/or configurations.

In some embodiments, in data and/or information sharing activator module 414 once the extracted data from Data and/or information and the file/files with HTML format associated with it is appropriately identified, verified, and id marked and stored, the operator(s) 102 (various entities, individual recruiter, a group of recruiters/individuals, individual, or freelancer) of computers processors 202 and/or one/or more groups of computers processors 204 can be assigned ownership of the submitted extracted data from data and/or information and the file/files with HTML format associated with it which can be identified, verified, and ID marked and stored. Data and/or information and the file/files with HTML format associated with such which is private to operator(s) 102 through computers processor(s) 202 and/or one/or more groups of computers processors 204 can be made public if the operator(s) 102 choose so via data and/or information sharing activator module 414. Once public, data and/or information and the file/files with HTML format associated with it can be searchable by other operator(s) 102.

Search program for shared data and/or information module 416 can aid operator(s) 102 (various entities, individual recruiter, a group of recruiters/individuals, individual, or freelancer) of computers processor(s) 202 and/or one/or more groups of computers processors 204 search public data and/or information and the file/files with HTML format associated with such. It can facilitate in data searching and in organizing and retrieving information efficiently. By way of non-limiting example, based on the required skill set primary and secondary search criteria can be searched against the stored public data and/or information and the file/files with HTML format associated with such. Primary search criteria can be the main terms or phrases that directly relate to desired skills. These search criteria can be broad in nature and reflect a central theme of the desired skills. By way of non-limiting example, if the desired skills are “Construction Project Manager,” then “Project Management” and/or “PMP” and/or “Construction” or any combination of such words may be considered primary search criterion. Secondary search criteria can be more specific terms or phrases that provide additional context or details related to the primary search criteria. Such search criteria can target niche or specialized topics within the broader theme covered by the primary search criteria. By way of non-limiting example, if the desired skills are “Construction Project Manager, ”then “Hotel” and/or “Road” and/or “Retail” could be considered secondary search criterion. In some embodiments, additional search criteria can also be used as search criteria.

When searching stored information with both primary and secondary search criteria, ordering of search results can impact the operator's 102 experience and the relevance of the retrieved information. In some embodiments, search results can be ordered based on the frequency of occurrence of both primary and secondary search criteria within the searched database entries. The search program for shared data and/or information module 416 can prioritize stored entries which contain the primary search criteria with the highest frequency, facilitating the prominent display of the most relevant and prominent matches. Subsequently, among entries with the same frequency of primary search criteria, search program for shared data and/or information module 416 further refines the order based on the frequency of appearance of secondary search criteria. Entries that contain the primary search criteria with the greatest frequency and the secondary search criteria with the highest frequency can be ranked at the top of the search results, followed by entries with decreasing frequencies of both primary and secondary search criteria. This ordering mechanism can be used to optimize the search experience by presenting operator(s) 102 with the most relevant and closely matched entries at the beginning of the results list, facilitating efficient information retrieval and enhancing an operator's 102 satisfaction with the database search process.

In some embodiments, a single item with same email id can be owned by multiple operators 102, each potentially customized with/without additional data or updates according to their preferences from the field data gathered at each operator's 102 level. The key condition is that each operator 102 acquired the item independently. An exception to independent acquisition is when items are purchased through the platform and subsequently updated independently on top of the originally purchased item. The search algorithm can prioritize search results based on item ratings and the operators 102 associated with them and latest update in terms of time. Accordingly, items with higher ratings and/or those owned by operators 102 with higher ranked reputations and/or most updated items can appear more prominently in search listings, enhancing visibility for Buyer/Rent operators 102.

Shared data and/or information transaction module 418 can facilitate operators 102 (various entities, individual recruiter, a group of recruiters/individuals, individual, or freelancer) of computers processors 202 and/or one/or more groups of computers processors 204 exchange public data and/or information and the file/files with HTML format associated with such, among themselves. The process can be initiated when a operators 102 identifies an item to rent/buy from the public data and/or information and the file/files with HTML format associated with such from the listings provided on the platform. The cost of the item in terms of tokens of the can be predetermined by the platform based, at least in part, on rating of the seller operators 102 and rating of the specific public data and/or information and the file/files with HTML format associated with such, as stored in the shared data and/or information feedback module 420. Buyer/Renter operators 102 can pay a predetermined token value for a specific public data and/or information and the file/files with HTML format associated with it, either to buy or rent the item. To enhance trust and security, the platform can employ an escrow-type service. Once the buyer/renter operators 102 agrees to buy/rent an item, the token payment can be temporarily held in escrow by the platform. This enhances the safeguards for both the buyer/renter operators' 102 token(s) and the seller operators' 102 item until the transaction is successfully completed. Upon receiving the item, the buyer/renter operator 102 can inspect it to ensure it matches the description provided by the seller operators 102 and meets their expectations. If satisfied, the buyer/renter can confirm receipt and accept the item within the platform's interface. Once the buyer/renter operator 102 confirms receipt and acceptance of the item, the platform can release the held tokens to the seller operator 102. This system can then complete the transaction process by transferring the tokens from escrow to the seller operator's 102 account.

Shared data and/or information feedback module 420 is adapted to facilitate feedback between buyer/renter operators 102 and seller operators 102 regarding the quality of shared public data and/or information and the file/files with HTML format associated with such. It can also serve to enhance transparency and trust within the online marketplace. This module can enable buyer/renter operators 102 and seller operators 102 to provide feedback and ratings based on their experiences with transactions. The module enables buyer/renter operators 102 to submit reviews and ratings regarding items they have bought/rented, offering detailed insights into their shared information correctness in terms of contact phone no, email and skills, satisfaction levels, perceived quality, and overall experience. These reviews can include written comments and/or numerical ratings, for seller operators 102 and the shared public data and/or information and the file/files with HTML format associated with such—i.e. items. The seller operator 102 can be numerically rated independently based on the numerical ratings of the volume of items and the numerical rating of seller operators 102 itself given by the buyer/renter operators 102. The module is adapted to provide the seller operator's 102 rating based on an average of all the rating it received for seller operators 102 public data and/or items.

Based on the ratings of the seller operators 102 and their submitted items, search program for shared data and/or information module 416 can present buyer/renter operators 102 with rated items. In some embodiments, based at least in part on the ratings of the seller operators 102 and their submitted items, data and/or information extractor/uploader module 408 can assign token valued and/or bonus tokens to items and/or updated items. The ratings of the seller operators 102 and their submitted items can, in some embodiment, be used by shared data and/or information transaction module 418 to establish bonus values for items of highly rated seller operators 102.

Shared data and/or information feedback module 420 can facilitate feedback between buyer/renter operators 102 and seller operator 102 and play a role in fostering accountability, transparency, and trust within talent marketplace. Shared data and/or information feedback module 420 can improve the quality of items within the system.

FIG. 5 depicts an embodiment of a plurality of single computer processors 202 in block diagram form. FIG. 5 shows a group 204 of single computer processors 202 which can interact with the host server computer 104. This group can contain any number of single computer processors 202 varying from 1 to n. G={a₁, a₂, . . . , aₙ}, a group with n single computer processors members. Group 204 can operate under the governance of a central computer processor. central computer processor can control group 204 in terms of single computer processors 202-member activity in the group 204. By way of non-limiting example, central computer processor can transmit/receive signals and/or data and/or information to/from the one or more single computer processor(s) 202 and/or one/or more group of computers processors 204 other then the group in which it is member via host server computer(s) 104 directly or indirectly or it can interact only with the group 204 which it is member of via host server computer(s) 104 directly. In some embodiments, each single computer processor 202 in a group 204 can connect individually or collectively to one or more storage group(s) 208 comprising any one or more of memory (ROM and RAM), group of memories, storage devices connected through network connections, interactions with other devices capable of storage which can contain any and/or all of the data and/or information described herein with regards database(s) 318 connected with the Host Server computer 104.

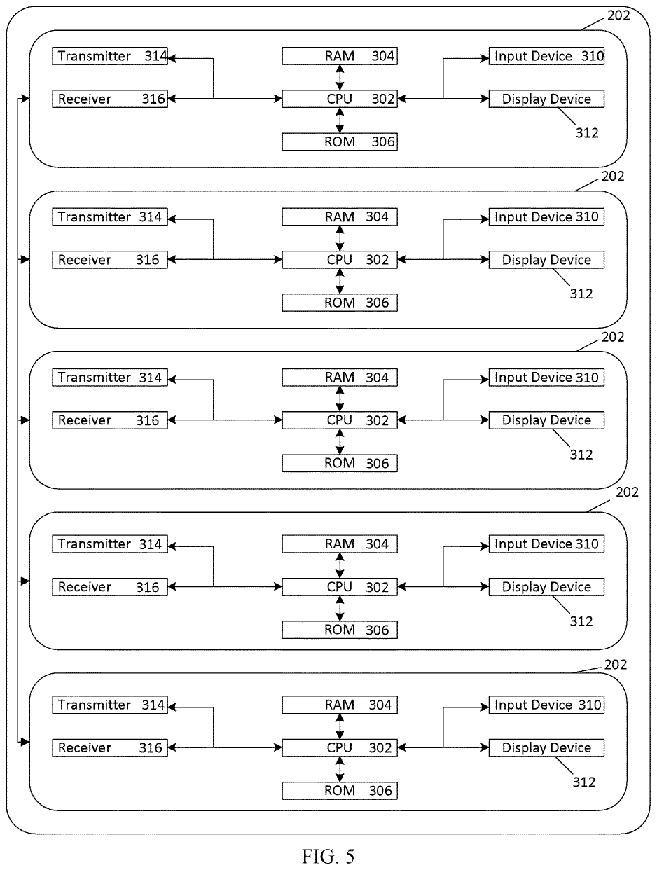

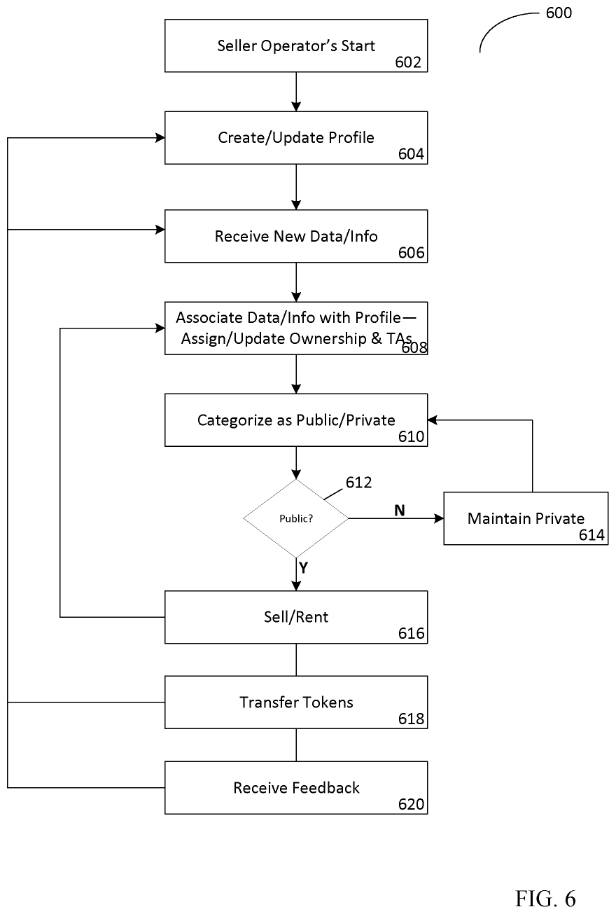

FIG. 6 depicts an embodiment of a function block diagram of the instantiation process 600. In the embodiment depicted in FIG. 6, a seller operator can initiate the process in step 602 and create a profile in step 604. In the embodiment of FIG. 6, apparatus operator(s) can be sellers of items.

In step 606, a seller operator can then upload new data/information related to an item, such as a resume associated with a job candidate. Additionally, seller operators can engage in creating or updating items, tracked by unique ownership IDs (step 608) established in the platform to facilitate identification of ownership rights and responsibilities for information accuracy. Furthermore, operators can be awarded token awards (TA) for uploading new or updated old items.

In step 610, seller operators can finalize the status of items by determining whether their uploaded/updated items will be public or private. Public items are searchable by the community, facilitating broader access, while private items are reserved for the operator's own use, maintaining confidentiality and control over access. This distinction facilitates efficient organization and management of items based on their intended audience and purpose. By making informed decisions at this stage, operators can effectively utilize resources and optimize the overall functionality of the platform. If the categorization is determined as private in step 612, then the system and method will proceed to step 614 and maintain the privacy of the item. However, if the item is determined to be categorized in step 612, then the item will be made available for sale/rent by other operators.

In step 616 a purchaser/renter can initiate a purchase or rental transaction associated with an item and the system and method can update ownership in step 608. Additionally in step 618, a token award transfer can be initiated between the seller operator and buyer operator transferring token awards to the seller's profile and debiting token awards from the buyer operator's profile and the profiles updates in steps 604 and or 606. In some embodiments, the purchase or rental transaction can be for the non-exclusive purchase or rental of the digital asset (item) thus enabling the sale/purchase or rental of the digital asset (item) to multiple buyer operators either at the same time or during overlapping time periods.

In step 620, a buyer operator can provide feedback from a buyer/renter operator to the seller operator regarding both the sold/rented items and the seller operator themselves and such can be used to update the seller's profile in step 604. These ratings can impact future earnings in token awards, directly impacting the reputation and trustworthiness of the seller operator within the platform. Positive feedback can enhance credibility of a seller's profile, potentially attracting more buyers/renters and leading to increased transactions and earnings. Conversely, negative feedback can deter future transactions and impact token award earnings. Thus, encouraging seller's to provide quality items to promote a higher rating.

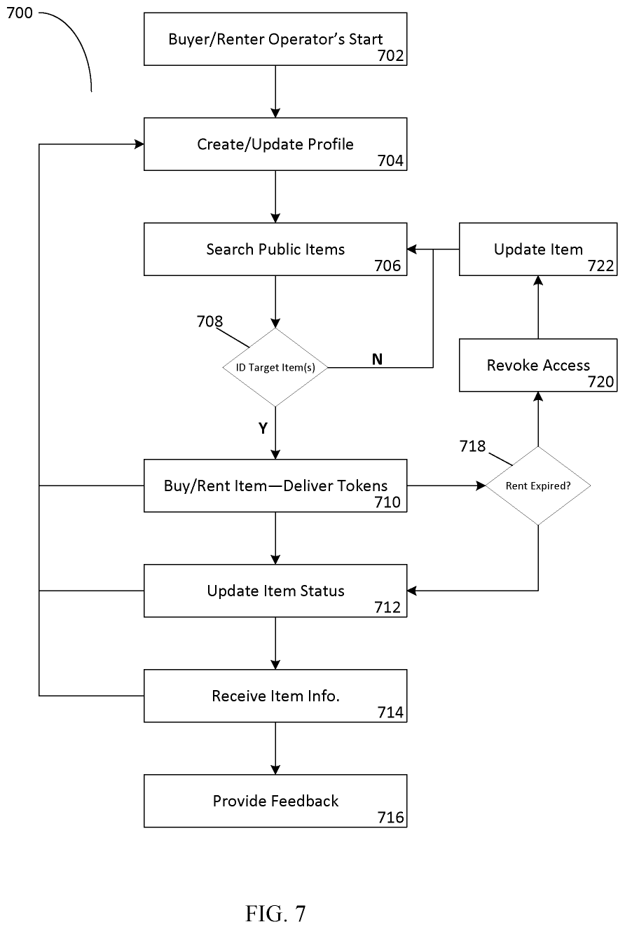

FIG. 7 depicts an embodiment of a function block diagram of the acquisition process 700. In the embodiment depicted in FIG. 7, a seller operator can initiate the process in step 702 and create a profile in step 704. In the embodiment of FIG. 7, apparatus operator(s) can be buyer/renter of items.

In step 706, a buyer/renter operator can initiate a task of searching for publicly shared items by other operators. This step can involve browsing through the platform's inventory to explore available items offered by different sellers or renters. By utilizing search filters and keywords, buyer/renter operators can narrow down their options and locate items that align with their specific preferences and desires.

In step 708 it can be determined whether a buyer/renter operator has identified a desirable item for acquisition. If in step 708 no desirable item is identified, the system and method can return to step 706 and additional searching can be conducted. If in step 708 one or more desirable items are identified for acquisition, the system and method can proceed to acquisition of the item(s) in step 710.

In step 710, a buyer/renter operator can engage in the process of purchasing or renting publicly available items by transferring token awards to a seller operator. This step comprises selecting desired items from the platform's listings and proceeding to initiate the transaction. By utilizing their allocated tokens, a buyer/renter operator can complete a transaction, thereby securing access to the chosen items for their intended use. In some embodiments, the purchase or rental transaction can be for the non-exclusive purchase or rental of the digital asset (item) thus enabling the sale/purchase or rental of the digital asset (item) to multiple buyer operators either at the same time or during overlapping time periods.

In step 712, the item status can be updated and the ownership update can be associated with the buyer/renter profile in step 704. Additionally, in step 714 the item can be delivered to buyer/renter.

In step 716, the Buyer/renter operator can participate by evaluating the performance through feedback of both the seller operator from whom the item was acquired and the individual items they've purchased or rented on the platform. This feedback can inform future transactions and interactions on the platform. By sharing their experience, a Buyer/renter operator can aid sellers in understanding their item(s)'s performance and, in some embodiments, token awards can be provided in return to incentive providing of feedback.

If in step 710 the transaction between seller operator and buyer/renter operator regarding the item is a rental of the item, then the system can proceed to step 718 to determine if the rental period is expired. If the rental period is determined not to be expired in step 718, the system can update the ownership status of the item in step 712 to maintain ownership/control by the buyer/renter operator, if ownership of the item was impacted by the purchase or rental transaction, such as in the exclusive sale of an item. In some embodiments, the purchase or rental transaction can be for the non-exclusive purchase or rental of the digital asset (item) thus enabling the sale/purchase or rental of the digital asset (item) to multiple buyer operators either at the same time or during overlapping time periods. However, if in step 718 it is determined that the rental period has expired, access to the item can be revoked for the buyer/renter operation in step 720 and the item status can be updated in step 722 and the item can be returned to public access or private access depending on the seller operator's desired preference, if public access was previously impacted or revoked. In alternate embodiments wherein rental of the time is a non-exclusive transaction, the seller operator can maintain control and ownership of the item at all times and can rent/sell the item to one or more alternate third parties.

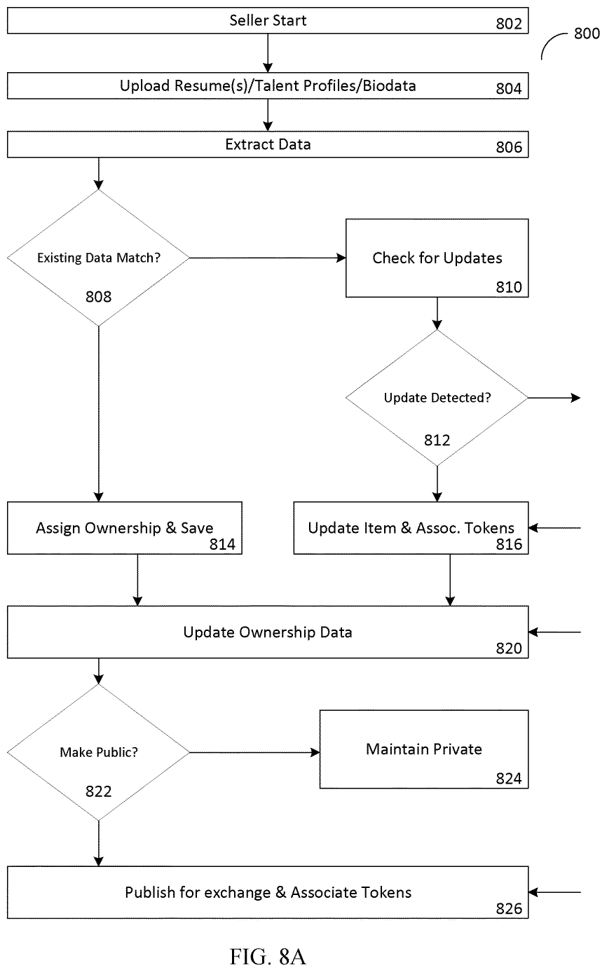

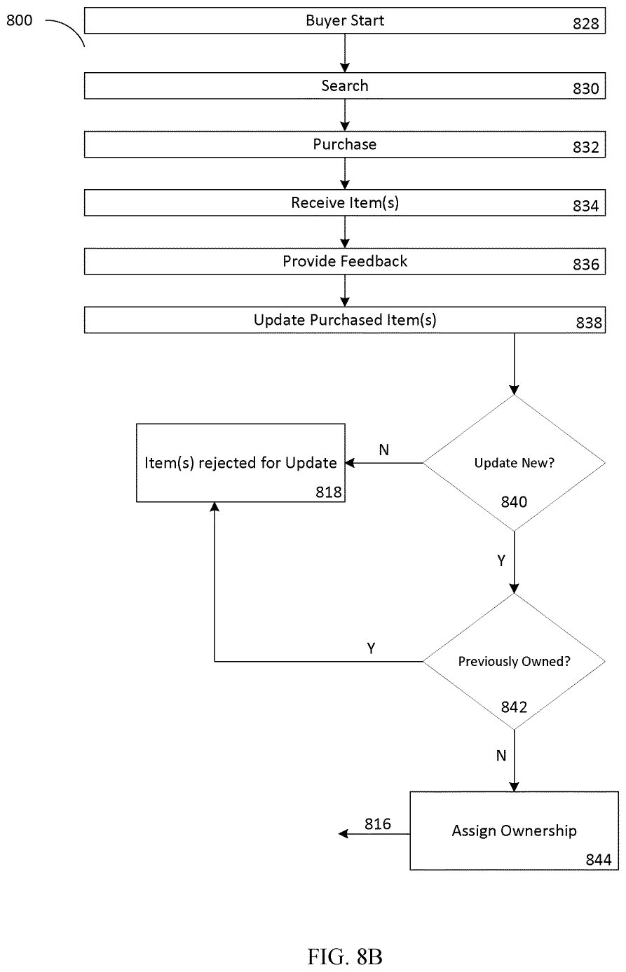

FIGS. 8A-8B depict an embodiment of a function block diagram of operation of the system and apparatus depicted in FIGS. 1-2B as utilized for a purchase wherein the purchase/sale can be an exclusive or non-exclusive purchase/sale of an item. The apparatus and method of the present system can be utilized in many embodiments to provide talent exchange services. FIGS. 8A-8B illustrate an embodiment of operation of the apparatus of FIGS. 1-2B, in flow diagram form. FIGS. 8A-8B illustrate a method for using apparatus and system 100, for facilitating talent information exchange by various entities, individual recruiter, a group of recruiters/individuals, individual, or freelancer. (hereinafter referred to collectively an operator with either having Buyer/renter operators 102 role who rent/purchase talent profiles (items) or seller-operators 102 role who sell/rent talent profiles (items). In some embodiments, operators 102 can be seller-operators, buyer-operators and/or can hold both rolls.

The operation of system 800 can commence at step 802. The operator 102 can use either single computer processor 202 and/or single machine in one/or more group of computers processors 204 (hereinafter referred to collectively as computer processors). In step 802, the operator 102 (seller-operators) (Operator A) can access the host server computer 104 via the computer processor 202.

In step 804, Operator A can upload resumes/talent profiles/biodata either in a batch or individually. In some embodiments such uploads can be computer files that store text in formats such as but not limited to Word documents, image file types, Rich Text Format (RTF) files, Text file Portable Document Format (PDF®) files, and Excel® spreadsheets.

In step 806, through extraction criteria and support provided by host server computer 104 hosted data and/or information extractor/uploader module 408, name, email, phone number, companies worked in, locations worked, work visa status, security clearance status, technologies worked in can be extracted from computer files (data and/or information) and the computer file type can be converted into HTML format without changing its original format and text layout of file/files. The information unit comprising extracted information and the HTML file created after this is herein termed an item.

In step 808 a check can be performed on the item(s) extracted in step 806 to determine if the uploaded item(s) exist in the platform under ownership of operator A. If the item(s) exist, then in step 812 a check can be performed for updates and difference in the old and new item(s).

If no new update and/or difference is found in the item(s), then the item(s) can be rejected for updates in step 818.

If differences are found the item(s) are versioned against the same ownership ID and Operator A can be credit a pre-determined token value for updates in step 816.

If in step 808 a check indicates new item(s) for Operator A, a new ownership ID can be assigned to the item(s) and stored on the platform in step 814, if the transaction is an exclusive sale/rental transaction. In embodiments wherein the transaction is a non-exclusive sale/rental transaction, the seller operator can maintain control and ownership of the item at all times and can rent/sell the item to one or more alternate third parties. That is, in some embodiments, the purchase or rental transaction can be for the non-exclusive purchase or rental of the digital asset (item) thus enabling the sale/purchase or rental of the digital asset (item) to multiple buyer operators either at the same time or during overlapping time periods.

In step 820 ownership data can be updated.

In step 822 Operator A can make some or all item(s) public. Public item(s) can be searched by other operators in step 826 and Operator A can earn a pre-determined token value for item(s) made public.

In step 824, the items which are not made public are available to Operator A as private searchable assets.

In step 828 another operator (Buyer/renter operator(s) 102) (herein, Operator B) can initiate operation and in step 830 Operator B can search public item(s) of Operator A or other such operators participating with their item(s) made public in the system.

In step 832 Operator B can select one or more item(s) which can be from Operator A or another such operator participating with their item(s) made public in the system and initiate a transaction to transfer a token value to the seller/renter of the item to respective operator for the item(s) Operator B desires to rent/purchase and non-exclusively or exclusively transfer the item in step 834.

In step 836 Operator B can provide feedback about item(s) rented/purchased from Operator A or other such operator participating with their item(s) in public domain and earn a token value for the feedback.

In step 838, Operator B can update the rented/purchased item(s) in the system with information regarding the item(s) independently collected outside the system.

In step 840, updates from step 838 can be checked against the purchased item(s) to determine if the update has unique aspects. If the updated is determined to contain no new unique aspects, the update can be rejected in step 818.

In step 842, if the updated item(s) were previously owned by the Operator B, item(s) the process proceeds to step 816 and the item can be updated and additional token value(s) can be assigned. However, if in step 842 it is determined that the item(s) was/were not previously owned by Operator B, then, in step 844 Operator B can be assigned ownership ID for the updated item(s) such that Operator B can non-exclusively or exclusively rent/sell that updated item and earn tokens for such. Accordingly, in some embodiments, the same basic item(s), but with differing versions, independently acquired or updated by different operators can be owned by multiple operators which can be offered for sale/rent independently by respective owner operators. Based on operators rating and item(s)'s rating, the search results can show display results with higher rating item(s) associated with higher rated operators presented in more prominent positions in the search results.

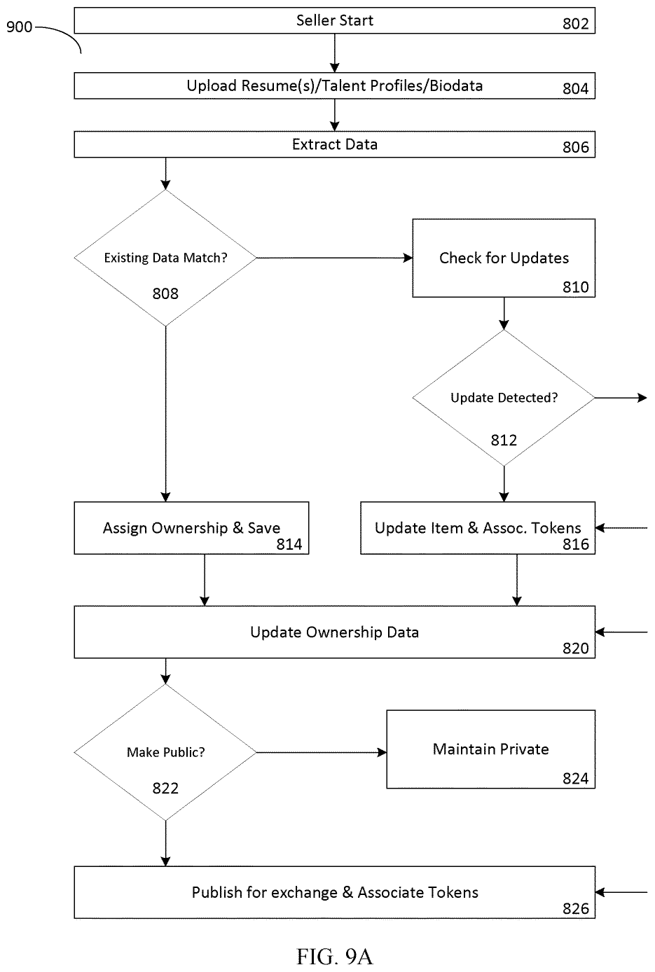

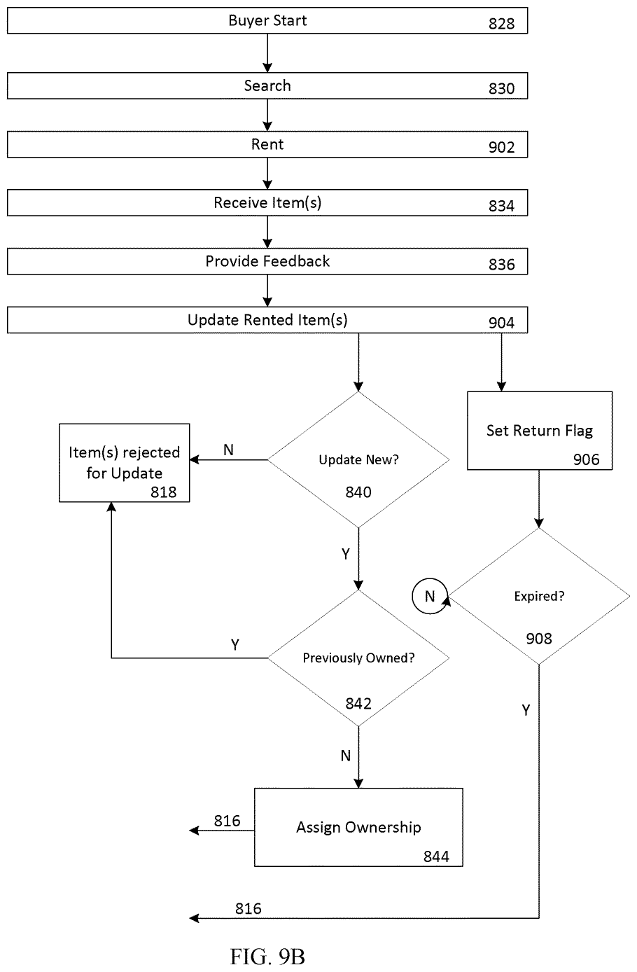

FIGS. 9A-9B depict an embodiment of a function block diagram of operation of the system and apparatus depicted in FIGS. 1-2B as utilized for a rental, wherein the rental can be an exclusive or non-exclusive rental of the item. The apparatus and method of the present system can be utilized in many embodiments to provide talent exchange services. FIGS. 9A-9B illustrate an embodiment of operation of the apparatus of FIGS. 1-2B, in flow diagram form. FIG. 9A 9B illustrate a method for using apparatus and system 100, for facilitating talent information exchange by various entities, individual recruiter, a group of recruiters/individuals, individual, or freelancer. (hereinafter referred to collectively an operator with either having Buyer/renter operators 102 role who rent/purchase talent profiles (items) or seller-operators 102 role who sell/rent talent profiles (items). In some embodiments, operators 102 can be seller-operators, buyer-operators and/or can hold both rolls.

The operation of system 900 can commence at step 802. Operator 102 can use either single computer processor 202 and/or single machine in one/or more group of computers processors 204 (hereinafter referred to collectively as computer processors). In step 802, the operator 102 (seller-operators) (Operator A) can access the host server computer 104 via the computer processor 202.

In step 804, Operator A can upload resumes/talent profiles/biodata either in a batch or individually. In some embodiments such uploads can be computer files that store text in formats such as but not limited to Word documents, image file types, Rich Text Format (RTF) files, Text file Portable Document Format (PDF®) files, and Excel® spreadsheets.

In step 806, through extraction criteria and support provided by host server computer 104 hosted data and/or information extractor/uploader module 408, name, email, phone number, companies worked in, locations worked, work visa status, security clearance status, technologies worked in can be extracted from computer files (data and/or information) and the computer file type can be converted into HTML format without changing its original format and text layout of file/files. The information unit comprising extracted information and the HTML file created after this is herein termed an item.

In step 808 a check can be performed on the item(s) extracted in step 806 to determine if the uploaded item(s) exist in the platform under ownership of operator A. If the item(s) exist, then in step 812 a check can be performed for updates and difference in the old and new item(s).

If no new update and/or difference is found in the item(s), then the item(s) can be rejected for updates in step 818.

If differences are found the item(s) are versioned against the same ownership ID and Operator A can be credit a pre-determined token value for updates in step 816.

If in step 808 a check indicates new item(s) for Operator A, a new ownership ID can be assigned to the item(s) and stored on the platform in step 814.

In step 820 ownership data can be updated.

In step 822 Operator A can make some or all item(s) public. Public item(s) can be searched by other operators in step 826 and Operator A can earn a pre-determined token value for item(s) made public.

In step 824, the items which are not made public are available to Operator A as private searchable assets.

In step 828 another operator (Buyer/renter operator(s) 102) (herein, Operator B) can initiate operation and in step 830 Operator B can search public item(s) of Operator A or other such operators participating with their item(s) made public in the system.

In step 902 Operator B can select one or more item(s) which can be from Operator A or another such operator participating with their item(s) made public in the system and initiate a transaction to transfer a token value to the seller/renter of the item to respective operator for the item(s) Operator B desires to non-exclusively or exclusively rent/purchase and exclusively or non-exclusively transfer the item in step 834. In some embodiments, the purchase or rental transaction can be for the non-exclusive purchase or rental of the digital asset (item) thus enabling the sale/purchase or rental of the digital asset (item) to multiple buyer operators either at the same time or during overlapping time periods.

In step 836 Operator B can provide feedback about item(s) rented/purchased from Operator A or other such operator participating with their item(s) in public domain and earn a token value for the feedback.

In step 904, Operator B can update the rented item(s) in the system with information regarding the item(s) independently collected outside the system.

In step 906, a return tag can be established based on the rental period, then in step 908 the system can determine whether the rental period has expired. Upon expiration of the rental period, the system can proceed to step 816 and the original item(s)' ownership can be updated. In embodiments wherein rental of the time is a non-exclusive transaction, the seller operator can maintain control and ownership of the item at all times and can rent/sell the item to one or more alternate third parties.

In step 840, updates from step 838 can be checked against the purchased item(s) to determine if the update has unique aspects. If the updated is determined to contain no new unique aspects, the update can be rejected in step 818.

In step 842, if the updated item(s) were previously owned by the Operator B, item(s) the process proceeds to step 816 and the item can be updated and additional token value(s) can be assigned. However, if in step 842 it is determined that the item(s) was/were not previously owned by Operator B, then, in step 844 Operator B can be assigned ownership ID for the updated item(s) such that Operator B can non-exclusively or exclusively rent/sell that updated item and earn tokens for such. Accordingly, in some embodiments, the same basic item(s), but with differing versions, independently acquired or updated by different operators can be owned by multiple operators which can be offered for non-exclusive or exclusive sale/rent independently by respective owner operators. Based on operators rating and item(s)'s rating, the search results can show display results with higher rating item(s) associated with higher rated operators presented in more prominent positions in the search results.

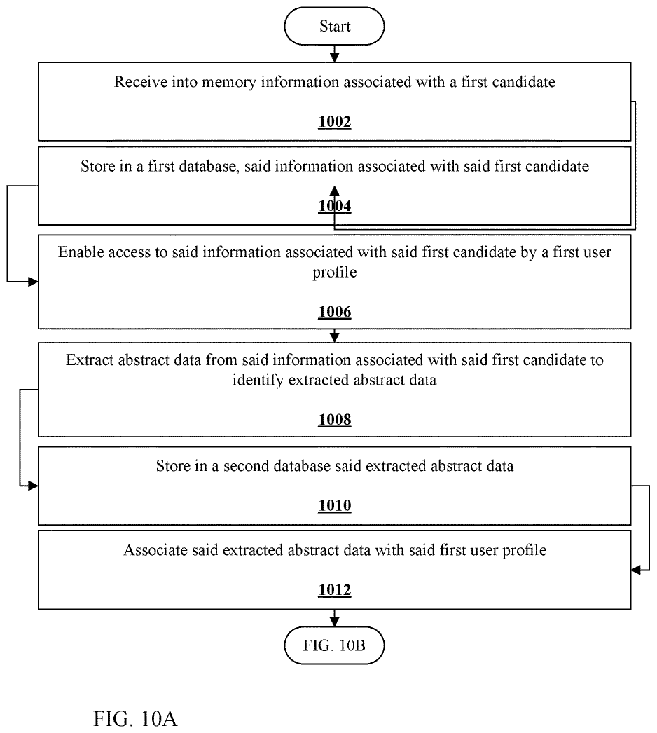

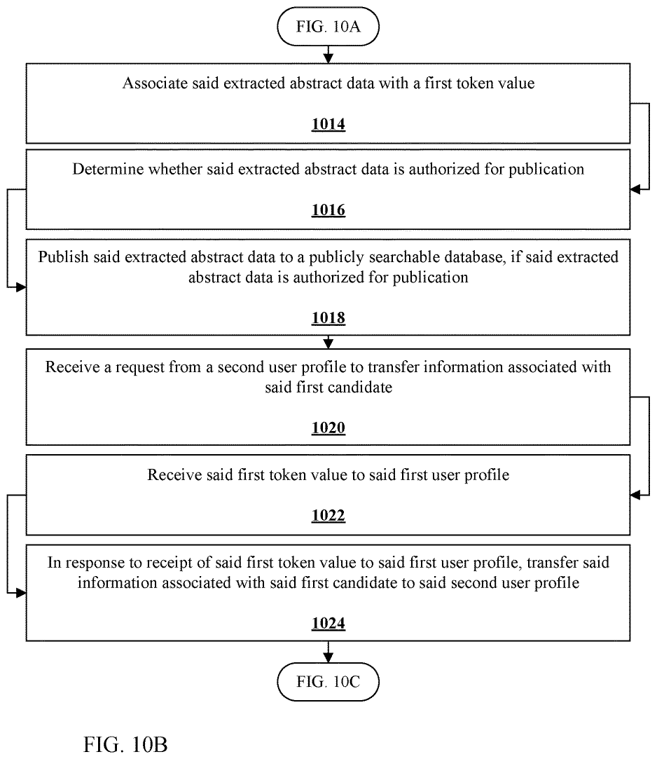

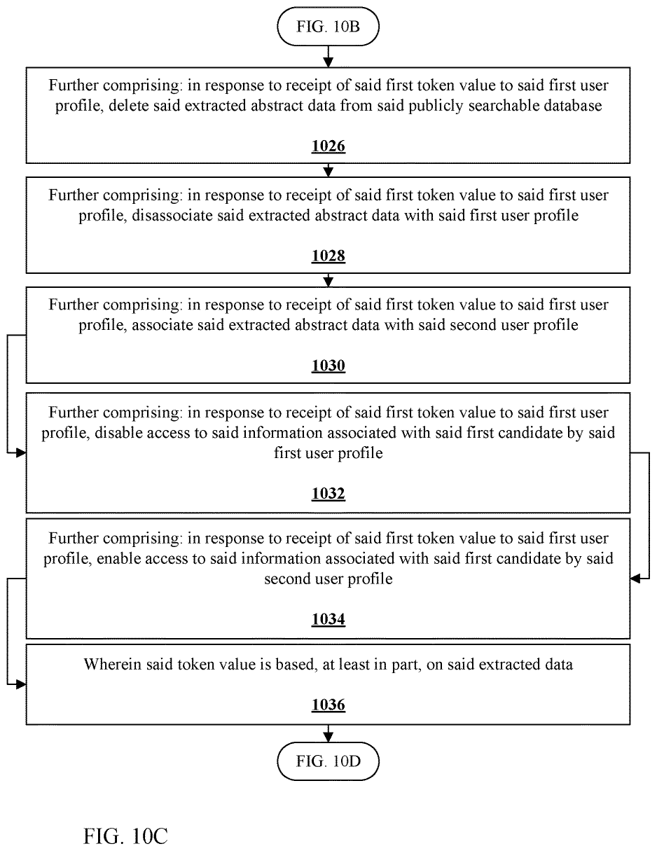

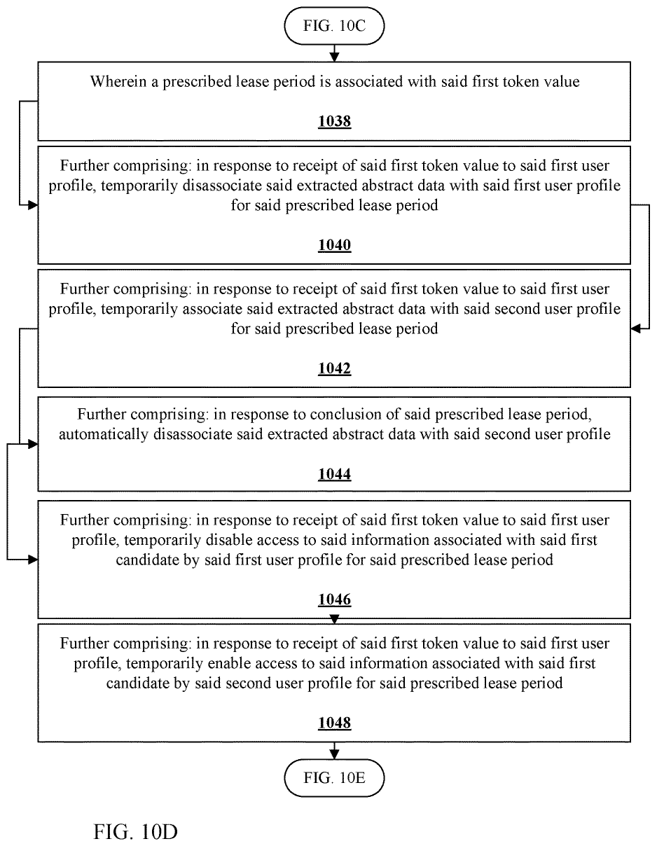

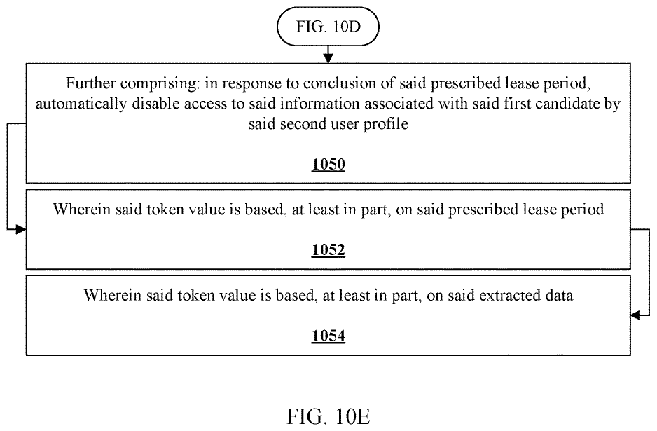

FIGS. 10A-10E depict a flowchart of an exemplary process 1000. In some implementations, one or more process blocks of FIGS. 10A-10E can be performed by a device. As shown in FIGS. 10A-10E, process 1000 can comprise receiving into memory information associated with a first candidate (block 1002). For example, the device can receive into memory information associated with a first candidate as described above. As also shown in FIGS. 10A-10E, process 1000 can comprise storing in a first database said information associated with said first candidate (block 1004). For example, the device can store in a first database said information associated with said first candidate as described above. As further shown in FIGS. 10A-10E, process 1000 can comprise enabling access to said information associated with said first candidate by a first user profile (block 1006). For example, the device can enable access to said information associated with said first candidate by a first user profile as described above. As also shown in FIGS. 10A-10E, process 1000 can comprise extracting abstract data from said information associated with said first candidate to identify extracted abstract data (block 1008). For example, the device can extract abstract data from said information associated with said first candidate to identify extracted abstract data as described above. As further shown in FIGS. 10A-10E, process 1000 can comprise storing in a second database said extracted abstract data (block 1010). For example, the device can store in a second database said extracted abstract data as described above. As also shown in FIGS. 10A-10E, process 1000 can comprise associating said extracted abstract data with said first user profile (block 1012). For example, the device can associate said extracted abstract data with said first user profile as described above. As further shown in FIGS. 10A-10E, process 1000 can comprise associating said extracted abstract data with a first token value (block 1014). For example, the device can associate said extracted abstract data with a first token value as described above. As also shown in FIGS. 10A-10E, process 1000 can comprise determining whether said extracted abstract data is authorized for publication (block 1016). For example, the device can determine whether said extracted abstract data is authorized for publication as described above. As further shown in FIGS. 10A-10E, process 1000 can comprise publishing said extracted abstract data to a publicly searchable database if said extracted abstract data is authorized for publication (block 1018). For example, the device can publish said extracted abstract data to a publicly searchable database if said extracted abstract data is authorized for publication as described above. As also shown in FIGS. 10A-10E, process 1000 can comprise receiving a request from a second user profile to transfer information associated with said first candidate (block 1020). For example, the device can receive a request from a second user profile to transfer information associated with said first candidate as described above. As further shown in FIGS. 10A-10E, process 1000 can comprise receiving said first token value to said first user profile (block 1022). For example, the device can receive said first token value to said first user profile as described above. As also shown in FIGS. 10A-10E, process 1000 can comprise, in response to receipt of said first token value to said first user profile, transferring said information associated with said first candidate to said second user profile (block 1024). For example, the device can, in response to receipt of said first token value to said first user profile, transfer said information associated with said first candidate to said second user profile as described above.

Process 1000 can comprise additional implementations, such as any single implementation or any combination of implementations described below and/or in connection with one or more other processes described elsewhere herein. In a first implementation, deleting said extracted abstract data from said publicly searchable database. In a second implementation, alone or in combination with the first implementation, disassociating said extracted abstract data with said first user profile. In a third implementation, alone or in combination with the first and second implementations, associating said extracted abstract data with said second user profile. In a fourth implementation, alone or in combination with one or more of the first through third implementations, disabling access to said information associated with said first candidate by said first user profile. In a fifth implementation, alone or in combination with one or more of the first through fourth implementations, enabling access to said information associated with said first candidate by said second user profile. In a sixth implementation, alone or in combination with one or more of the first through fifth implementations, at least in part on said extracted data. In a seventh implementation, alone or in combination with one or more of the first through sixth implementations, the method of claim 1 where a prescribed lease period is associated with said first token value. In an eighth implementation, alone or in combination with one or more of the first through seventh implementations, temporarily disassociating said extracted abstract data with said first user profile for said prescribed lease period. In a ninth implementation, alone or in combination with one or more of the first through eighth implementations, temporarily associating said extracted abstract data with said second user profile for said prescribed lease period. In a tenth implementation, alone or in combination with one or more of the first through ninth implementations, automatically disassociating said extracted abstract data with said second user profile. In an eleventh implementation, alone or in combination with one or more of the first through tenth implementations, temporarily disabling access to said information associated with said first candidate by said first user profile for said prescribed lease period. In a twelfth implementation, alone or in combination with one or more of the first through eleventh implementations, temporarily enabling access to said information associated with said first candidate by said second user profile for said prescribed lease period. In a thirteenth implementation, alone or in combination with one or more of the first through twelfth implementations, automatically disabling access to said information associated with said first candidate by said second user profile. In a fourteenth implementation, alone or in combination with one or more of the first through thirteenth implementations, at least in part on said prescribed lease period. In a fifteenth implementation, alone or in combination with one or more of the first through fourteenth implementations, at least in part on said extracted data.

Although FIGS. 10A-10E show example blocks of process 1000, in some implementations, process 1000 can comprise additional blocks, fewer blocks, different blocks, or differently arranged blocks than those depicted in FIGS. 10A-10E. Additionally or alternatively, two or more of the blocks of process 1000 can be performed in parallel.

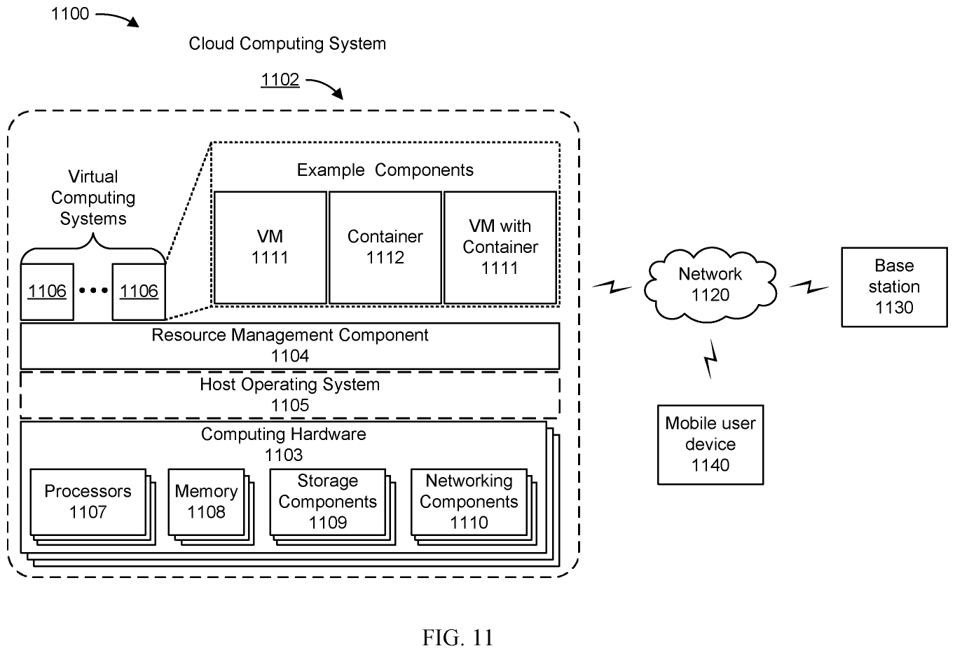

FIG. 11 is a diagram of an example environment 1100 in which systems and/or methods described herein can be implemented. As shown in FIG. 11, the environment 1100 can execute within a cloud computing system 1102. The cloud computing system 1102 can comprise one or more elements 1103-1111, as described in more detail below. As further shown in FIG. 11, the environment 1100 can comprise a network 1120, a base station 1130, and/or a user device 1140. Devices and/or elements of the environment 1100 can interconnect via wired connections and/or wireless connections.

The cloud computing system 1102 comprises computing hardware 1103, a resource management component 1104, a host operating system (OS) 1105, and/or one or more virtual computing systems 1106. The resource management component 1104 can perform virtualization (e.g., abstraction) of the computing hardware 1103 to create the one or more virtual computing systems 1106. Using virtualization, the resource management component 1104 enables a single computing device (e.g., a computer, a server, and/or the like) to operate like multiple computing devices, such as by creating multiple isolated virtual computing systems 1106 from the computing hardware 1103 of the single computing device. In this way, the computing hardware 1103 can operate more efficiently, with lower power consumption, higher reliability, higher availability, higher utilization, greater flexibility, and lower cost than using separate computing devices.

The computing hardware 1103 comprises hardware and corresponding resources from one or more computing devices. For example, the computing hardware 1103 can comprise hardware from a single computing device (e.g., a single server) or from multiple computing devices (e.g., multiple servers), such as multiple computing devices in one or more data centers. As shown, the computing hardware 1103 can comprise one or more processors 1107, one or more memories 1108, one or more storage components 1109, and/or one or more networking components 1110. Examples of a processor, a memory, a storage component, and a networking component (e.g., a communication component) are described elsewhere herein.

The resource management component 1104 comprises a virtualization application (e.g., executing on hardware, such as the computing hardware 1103) capable of virtualizing the computing hardware 1103 to start, stop, and/or manage the one or more virtual computing systems 1106. For example, the resource management component 1104 can comprise a hypervisor (e.g., a bare-metal or Type 11 hypervisor, a hosted or Type 2 hypervisor, and/or the like) or a virtual machine monitor, such as when the virtual computing systems 1106 are virtual machines 1111. Additionally, or alternatively, the resource management component 1104 can comprise a container manager, such as when the virtual computing systems 1106 are containers 1112. In some implementations, the resource management component 1104 executes within and/or in coordination with a host operating system 1105.

A virtual computing system 1106 comprises a virtual environment that enables cloud-based execution of operations and/or processes described herein using computing hardware 1103. As shown, the virtual computing system 1106 can comprise a virtual machine 1111, a container 1112, a hybrid environment 1111 that comprises a virtual machine and a container, and/or the like. A virtual computing system 1106 can execute one or more applications using a file system that comprises binary files, software libraries, and/or other resources required to execute applications on a guest operating system (e.g., within the virtual computing system 1106) or the host operating system 1105.

The network 1120 comprises one or more wired and/or wireless networks. For example, the network 1120 can comprise a cellular network, a public land mobile network (PLMN), a local area network (LAN), a wide area network (WAN), a private network, the Internet, and/or the like, and/or a combination of these or other types of networks. The network 1120 enables communication among the devices of the environment 1100.

The base station 1130 can support, for example, a cellular radio access technology (RAT). The base station can comprise one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the user device 1140. The base station 1130 can transfer traffic between the user device 1140 (e.g., using a cellular RAT), one or more base stations (e.g., using a wireless interface or a backhaul interface, such as a wired backhaul interface), and/or a core network. The base station 1130 can provide one or more cells that cover geographic areas.

The user device 1140 comprises one or more devices capable of receiving, generating, storing, processing, and/or providing information, as described elsewhere herein. The user device 1140 can comprise a communication device and/or a computing device. For example, the user device 1140 can comprise a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 11 are provided as an example. In practice, there can be additional devices and/or networks, fewer devices and/or networks, different devices and/or networks, or differently arranged devices and/or networks than those shown in FIG. 11. Furthermore, two or more devices shown in FIG. 11 can be implemented within a single device, or a single device shown in FIG. 11 can be implemented as multiple, distributed devices. Additionally, or alternatively, a set of devices (e.g., one or more devices) of the environment 1100 can perform one or more functions described as being performed by another set of devices of the environment 1100.

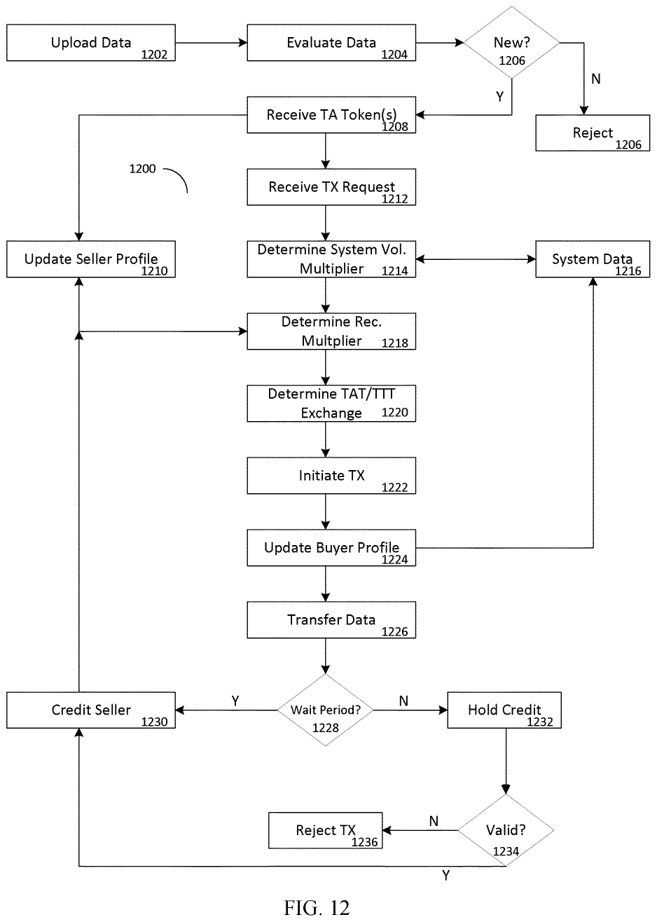

FIG. 12 depicts an embodiment of a functional flow block diagram for exchange of tokens 1200. In the embodiment depicted in FIG. 12, the data related to an item can be uploaded in step 1202 and the data evaluated in step 1204 to determine if the data related to the item contains new information.

If it is determined in step 1206 that the data related to the item does not contain new information, the upload will be rejected and the process can cease. If in step 1206 it is determined that the data related to the item contains new information, then the system can provide a token award (TA) associated with the uploaded data associated with the item in step 1208. Then in step 1210 a profile can be updated to reflect the token award of the operator providing the data related to the item. The system and process then proceed to step 1212.

In step 1212, a transfer request can be received from a purchasing/renting operator seeking to either purchase or rent the data associated with an item. At the time of the transaction, a system volume multiplier can be determined in step 1214 by accessing system data 1216. In some embodiments, the system volume multiplier can be based at least in part on one of multiple system factors such as, number of items in the systema, number of operators and/or number of transactions within the system.

In step 1218, profile data 1212 can be accessed to determine a multiplier associated with a particular operator/profile, which can be based on any factor associated with a profile and/or operator.

In step 1220, a token award to talent transaction token (TTT) exchange rate can be established based at least in part on one or more of the multipliers determined in steps 1214 and 1218. Then in step 1222 a transfer/exchange of token awards for talent transaction tokens can be initiated and a quantity of TTTs can be provided in exchange for a quantity of TAs.

A buyer's profile can then be updated in step 1224 and data associated with an item can then be exchanged in step 1226.

In some embodiments, a waiting period can be established. In such embodiments, if in step 1228 it is determined that a waiting period has passed, then a sell can be credited in step 1230 and the seller's profile updated in step 1210. However, if in step 1228 it is determined that the waiting period has not passed, credit to the seller's profile can be held in step 1232 and then the system can proceed to validating the transaction in step 1234 to ensure that the transaction, profile, data and waiting period terms are satisfied. If such are not satisfied in step 1234, the transaction can be rejected in step 1236. If such are satisfied in step 1234, then the system can proceed to step 1230 and credit the seller and update the seller's profile in step 1210.

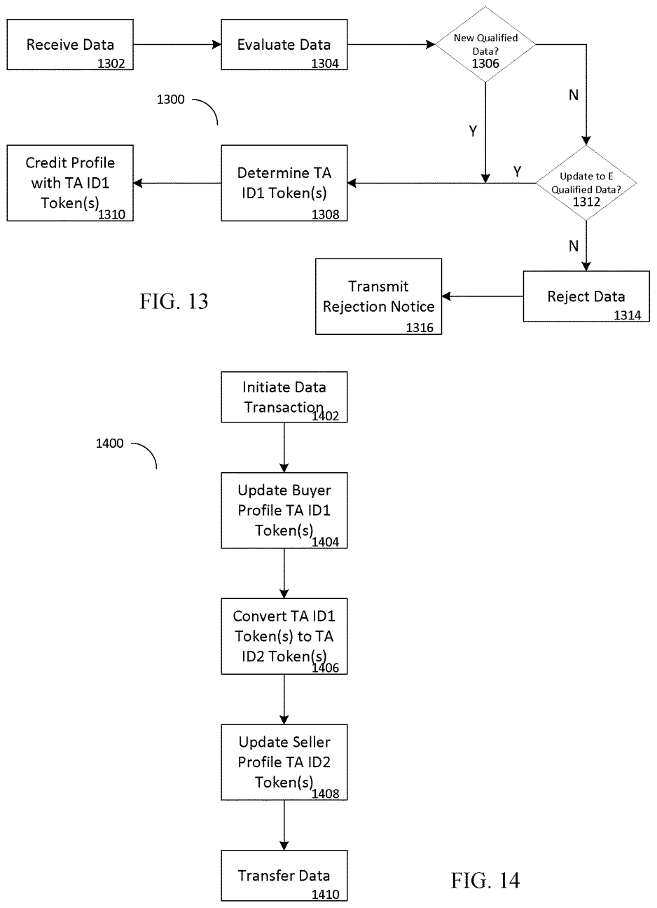

FIG. 13 depicts an embodiment of a functional flow block diagram for upload of items to the system 1300. In step 1302, data regarding an item can be received and the data can be parsed and evaluated in step 1304.

In step 1306, it can be determined whether the data regarding the item is qualified as new data or known data. If in step 1306 it is determined that the data regarding the item is new qualified data, then the system and method can proceed to step 1308 and a first (ID1) token award can be determined based at least in part on the data received in step 1306 and the evaluation of the data in step 1304. Then in step 1310, the determined token award (TD1) can be credited to the profile/processor associated with the data provided in step 1302.

However, if in step 1306 it is determined that the data is not new qualified data, then in step 1312 it can be determined whether the data represents a qualified update to previously known data. If in step 1312 it is determined that the data received in step 1302 constitutes an update to previously qualified data, then the system and method can proceed to steps 1308 and 1310 in which a token award value is determined and applied to a profile/processor. However, if in step 1312, it is determined that the data does not represent a qualified update to previously known data, the system and method can reject the data in step 1314 and transmit a notice of rejection to the profile/processor in step 1316.

FIG. 14 depicts an embodiment of a functional flow block diagram for exchange of items within the system 1400. In the embodiment depicted in FIG. 14, data can be exchanged between and seller-operator and purchaser/renter-operator and token awards can be converted from a first type from ID1 (provided/earned for upload of new data to the system) token awards to ID2 token awards, provided/earned when an items is sold or rented to another operator. In step 1402, a data exchange transaction can be initiated by an operator desiring to rent or purchase an item. In response to the initiation in step 1402, the buyer (operator) profile can be updated to reflect the deduction of ID1 tokens awards due to the seller (operator) profile in exchange for the item.

Then in step 1406, an exchange rate for ID1 to ID2 token awards can be established—ID2 token awards being provided to the seller (operator) profile in exchange for the transfer of the item to the buyer (operator) profile. In some embodiments, ID1 to ID2 token awards can have a 1:1 exchange ratio. However, in alternate embodiments, various exchange ratios and/or variable exchange ratios can be employed. In some embodiments, the exchange ratio can be determined, at least in part, on a profile (operator) ranking/rating and/or a token value associated with an item.

In step 1408, the seller (operator) profile can be credited with ID2 token awards as determined in step 1406 and the data related to the item can be transferred to the buyer/renter (operator) profile.

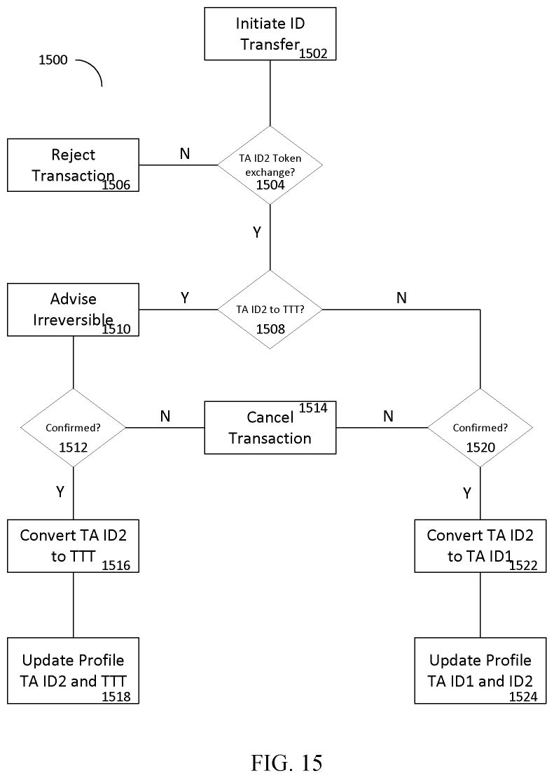

FIG. 15 depicts an embodiment of a functional flow block diagram for exchange of tokens within the system 1500. In some embodiments, token awards ID2 can be exchanged for ID1 token awards and/or talent transaction token awards (TTTs). In the method and system depicted in FIG. 15, an exchange transaction of ID2 token awards can be initiate in step 1502. In step 1504, the system and method can evaluate whether the transaction is for the exchange of ID2 token awards. If in step 1504, it is determined that the transaction is not attempting to exchange ID2 token awards, then the transaction can be rejected in step 1506, otherwise the method and system can advance to step 1508.

In step 1508, it can be determined whether the desired exchange transaction is an ID2 to ID1 transaction or an ID2 to TTT transaction. If the desired exchange transaction and ID2 to TTT transaction, the operator can be advised that the exchange is not reversible in step 1510. In some embodiments, ID2 to TTT token awards can have a 1:1 exchange ratio. However, in alternate embodiments, various exchange ratios and/or variable exchange ratios can be employed. In some embodiments, the exchange ratio can be determined, at least in part, on a profile (operator) ranking/rating and/or a token value associated with an item and/or system volumes and/or any other known, convenient and/or desired input.

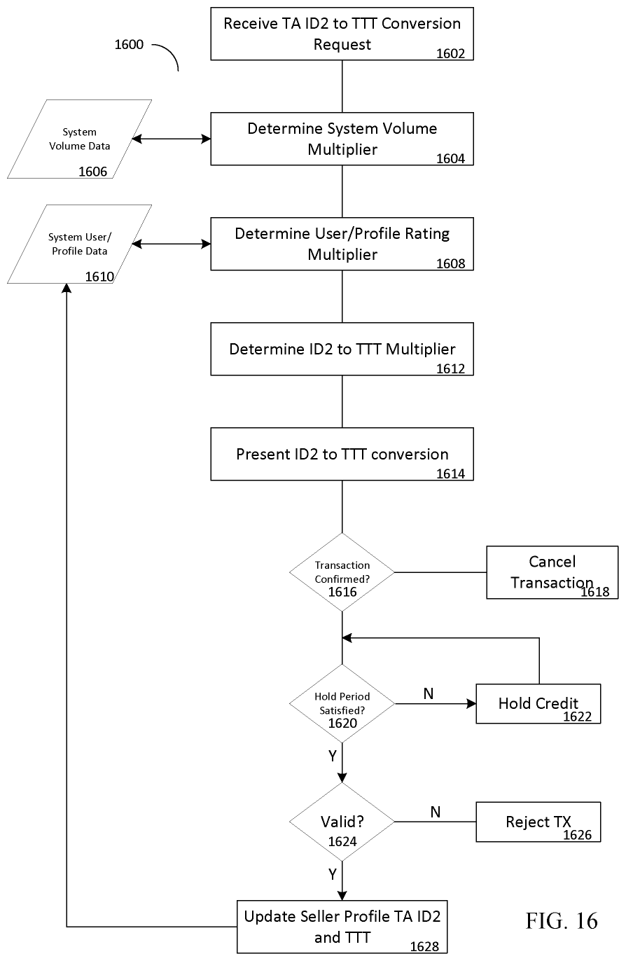

A proposed exchange TTT token award value in exchange for the ID2 token awards can then be determined and presented in step 1512. If in step 1512, an operator is dissatisfied with the TTT token awards to be provided in exchange for the ID2 token awards, the transaction can be cancelled in step 1514. If in step 1512, an operator is satisfied with the TTT token awards to be provided in exchange for the ID2 token awards, the exchange of ID2 token awards can proceed in step 1516 and the profile can be updated to reflect a reduction in ID2 token awards and an increase in TTT token awards. In some embodiments, a ID2 to TTT token awards exchange rate can be determined in accordance with system and method described in relation to FIG. 16 herein.

If in step 1508 it is determined that the desired transaction is an exchange of ID2 to ID2 token awards, then in step 1520 the exchange can be presented and confirmed. If in step 1520, an operator is dissatisfied with the ID1 token awards to be provided in exchange for the ID2 token awards, the transaction can be cancelled in step 1514. If in step 1520, an operator is satisfied with the ID1 token awards to be provided in exchange for the ID2 token awards, the exchange of ID2 token awards can proceed in step 1522 and the profile can be updated to reflect a reduction in ID2 token awards and an increase in ID1 token awards.

In some embodiments, ID2 to ID1 token awards can have a 1:1 exchange ratio. However, in alternate embodiments, various exchange ratios and/or variable exchange ratios can be employed. In some embodiments, the exchange ratio can be determined, at least in part, on a profile (operator) ranking/rating and/or a token value associated with an item and/or system volumes and/or any other known, convenient and/or desired input.

FIG. 16 depicts an embodiment of a functional flow block diagram for exchange of tokens within the system 1600. In the embodiment depicted in FIG. 16, a weighted transaction system and method for exchange of ID2 token awards for TTT token awards is presented. In step 1602, an ID2 to TTT token award exchange is initiated. In response, a system volume multiplier is determined in step 1604 by accessing system volume data 1606. System volume data can be associated with any system volume number, such as total number of items within the system, total transactions with the system, total transactions with the system within a prescribed period of time, total transactions for an operator (temporally limited or unrestricted), total transactions for a given geographic region (temporally limited or unrestricted), total transactions associated with a particular characteristic of given items (temporally limited or unrestricted), and/or any other known convenient and/or desired volume information associated with the system. By way of non-limiting example, in some embodiments, a multiplier can be less than 1 or 1 when a prescribed system volume is less than a first threshold and be 1.1 when a prescribed system volume is between two prescribed values and 1.2 when a prescribed system volume is able the higher of the two prescribed values. In various embodiments, multiple thresholds and/or bands can be defined and various, desired values can be set for the relevant thresholds.

In step 1608 a user/profile rating multiplier can be identified. In some embodiments, a user/profile rating can be established based on ratings provided for a user/profile's previous transactions and/or evaluations associated with data associated with items previously provided by a user/profile. In various embodiments, the user/profile rating multiplier can be less than, equal to or greater than 1. Information regarding the user/profile can be obtained by accessing the system's user/profile data in step 1610.

In step 1612, an ID2 to TTT multiplier can be determined by any known convenient and/or desired combination of the system volume multiplier and the user/profile multiplier. By way of non-limiting example, in some embodiments, the ID2 to TTT multiplier can be the simple product of the system volume multiplier and the user/profile multiplier. However, in alternate embodiments the ID2 to TTT multiplier can be the weighted product of such values and/or the combination of such values in any known, convenient and/or desired manner. After determination of the ID2 to TTT multiplier, it can be presented to a user in step 1614 for approval.

In step 1616 if the ID2 to TTT multiplier and associated transaction (exchanging ID2 for TTT token awards) is not approved, the transaction can be cancelled in step 1618. However, if in step 1616 if the ID2 to TTT multiplier and associated transaction (exchanging ID2 for TTT token awards) is approved, the system can proceed to step 1620.

In step 1620, the system and method can determine if a prescribed hold period has passed. If the prescribed hold period has not passed, then the system and method can place the transaction on hold in step 1622 and the system can cycle check to determine when the hold period has passed such that the system and method can proceed to step 1624.

In step 1624, the system and method can evaluate the transaction to determine if the transaction presents concerns or is valid, by evaluation of various known, convenient and/or desired aspects of the transaction. In some embodiments, if the transaction is not determined to be valid, the transaction can be rejected in step 1626. However, if the transaction is determined to be valid in step 1624 a user/seller's profile update can be identified in step 1628 (reducing a profile's ID2 token award count and increasing the profile's TTT token award count) and the user/profile data can be updated in step 1610.

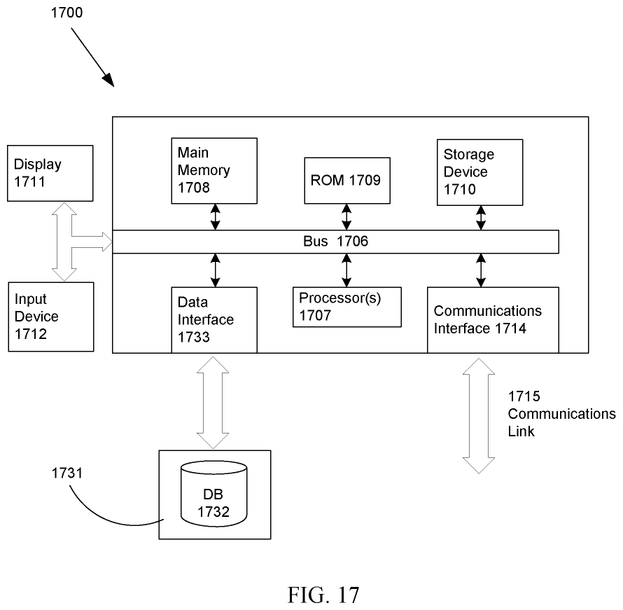

The execution of the sequences of instructions required to practice the embodiments can be performed by a computer system 1700 as shown in FIG. 17. In some embodiments, execution of the sequences of instructions is performed by a single computer system 1700. According to other embodiments, two or more computer systems 1700 coupled by a communication link 1715 can perform the sequence of instructions in coordination with one another. Although a description of only one computer system 1700 will be presented below, however, it should be understood that any number of computer systems 1700 can be employed to practice the embodiments.

A computer system 1700 according to an embodiment will now be described with reference to FIG. 17, which is a block diagram of the functional components of a computer system 1700. As used herein, the term computer system 1700 is broadly used to describe any computing device that can store and independently run one or more programs.

Each computer system 1700 can comprise a communication interface 1714 coupled to the bus 1706. The communication interface 1714 provides two-way communication between computer systems 1700. The communication interface 1714 of a respective computer system 1700 transmits and receives electrical, electromagnetic or optical signals, that include data streams representing various types of signal information, e.g., instructions, messages and data. A communication link 1715 links one computer system 1700 with another computer system 1700. For example, the communication link 1715 can be a LAN, in which case the communication interface 1714 can be a LAN card, or the communication link 1715 can be a PSTN, in which case the communication interface 1714 can be an integrated services digital network (ISDN) card or a modem, or the communication link 1715 can be the Internet, in which case the communication interface 1714 can be a dial-up, cable or wireless modem.

A computer system 1700 can transmit and receive messages, data, and instructions, including program, i.e., application, code, through its respective communication link 1715 and communication interface 1714. Received program code can be executed by the respective processor(s) 1707 as it is received, and/or stored in the storage device 1710, or other associated non-volatile media, for later execution.

In an embodiment, the computer system 1700 operates in conjunction with a data storage system 1731, e.g., a data storage system 1731 that contains a database 1732 that is readily accessible by the computer system 1700. The computer system 1700 communicates with the data storage system 1731 through a data interface 1733. A data interface 1733, which is coupled to the bus 1706, transmits and receives electrical, electromagnetic or optical signals, that include data streams representing various types of signal information, e.g., instructions, messages and data. In embodiments, the functions of the data interface 1733 can be performed by the communication interface 1714.

Computer system 1700 comprises a bus 1706 or other communication mechanism for communicating instructions, messages and data, collectively, information, and one or more processors 1707 coupled with the bus 1706 for processing information. Computer system 1700 can comprise a main memory 1708, such as a random access memory (RAM) or other dynamic storage device, coupled to the bus 1706 for storing dynamic data and instructions to be executed by the processor(s) 1707. The main memory 1708 also can be used for storing temporary data, i.e., variables, or other intermediate information during execution of instructions by the processor(s) 1707.

The computer system 1700 can further include a read only memory (ROM) 1709 or other static storage device coupled to the bus 1706 for storing static data and instructions for the processor(s) 1707. A storage device 1710, such as a magnetic disk or optical disk, can also be provided and coupled to the bus 1706 for storing data and instructions for the processor(s) 1707.

A computer system 1700 can be coupled via the bus 1706 to a display device 1711, such as, but not limited to, a cathode ray tube (CRT) or a liquid-crystal display (LCD) monitor, for displaying information to a user. An input device 1712, e.g., alphanumeric and other keys, is coupled to the bus 1706 for communicating information and command selections to the processor(s) 1707.

According to one embodiment, an individual computer system 1700 performs specific operations by their respective processor(s) 1707 executing one or more sequences of one or more instructions contained in the main memory 1708. Such instructions can be read into the main memory 1708 from another computer-usable medium, such as the ROM 1709 or the storage device 1710. Execution of the sequences of instructions contained in the main memory 1708 causes the processor(s) 1707 to perform the processes described herein. In alternative embodiments, hard-wired circuitry can be used in place of or in combination with software instructions. Thus, embodiments are not limited to any specific combination of hardware circuitry and/or software.

The term “computer-usable medium,” as used herein, refers to any medium that provides information or is usable by the processor(s) 1707. Such a medium can take many forms, including, but not limited to, non-volatile, volatile and transmission media. Non-volatile media, i.e., media that can retain information in the absence of power, comprises the ROM 1709, CD ROM, magnetic tape, and magnetic discs. Volatile media, i.e., media that can not retain information in the absence of power, comprises the main memory 1708. Transmission media comprises coaxial cables, copper wire and fiber optics, including the wires that comprise the bus 1706. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes can be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the presented systems, methods and apparatuses can be implemented in a variety of computer systems. The various techniques described herein can be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high-level procedural or object oriented programming language to communicate with a computer system. However, the programs can be implemented in assembly or machine language, if desired. In any case, the language can be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system can also be considered to be implemented as a computer-readable storage medium, configured with a computer program, where the storage medium so configured causes a computer to operate in a specific and predefined manner. Further, the storage elements of the exemplary computing applications can be relational or sequential (flat file) type computing databases that are capable of storing data in various combinations and configurations.

Examples of memory include random access memory (RAM), read only memory (ROM), or both. Memory can store instructions, such as source code or binary code, for performing the techniques described above.

A storage device can also store instructions, instructions, such as source code or binary code, for performing the techniques described above. A storage device can additionally store data used and manipulated by the computer processor

A memory or storage device can be an example of a non-transitory computer-readable storage medium for use by or in connection with the video encoder and/or decoder. The non-transitory computer-readable storage medium contains instructions for controlling a computer system to be configured to perform functions described by particular embodiments. The instructions, when executed by one or more computer processors, can be configured to perform that which is described in particular embodiments.

Also, it is noted that some embodiments have been described as a process which can be depicted as a flow diagram or block diagram. Although each can describe the operations as a sequential process, many of the operations can be performed in parallel or concurrently. In addition, the order of the operations can be rearranged. A process can have additional steps not included in the figures.

Particular embodiments can be implemented in a non-transitory computer-readable storage medium for use by or in connection with the instruction execution system, apparatus, system, or machine. The computer-readable storage medium contains instructions for controlling a computer system to perform a method described by particular embodiments. The computer system can comprise one or more computing devices. The instructions, when executed by one or more computer processors, can be configured to perform that which is described in particular embodiments

The foregoing disclosure provides illustration and description but is not intended to be exhaustive or to limit the implementations to the precise form disclosed. Modifications can be made in light of the above disclosure or can be acquired from practice of the implementations. As used herein, the term “component” is intended to be broadly construed as hardware, firmware, or a combination of hardware and software. It will be apparent that systems and/or methods described herein can be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein. As used herein, satisfying a threshold can, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features can be combined in ways not specifically recited in the claims and/or disclosed in the specification.

Although each dependent claim listed below can directly depend on only one claim, the disclosure of various implementations comprises each dependent claim in combination with every other claim in the claim set. No element, act, or instruction used herein should be construed as critical or essential unless explicitly described as such. Also, as used herein, the articles “a” and “an” are intended to include one or more items and can be used interchangeably with “one or more.” Further, as used herein, the article “the” is intended to include one or more items referenced in connection with the article “the” and can be used interchangeably with “the one or more.” Furthermore, as used herein, the term “set” is intended to include one or more items (e.g., related items, unrelated items, a combination of related and unrelated items, and/or the like), and can be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used in the description herein and throughout the claims that follow, the meaning of “in” comprises “in” and “on” unless the context clearly dictates otherwise. Also, as used herein, the term “or” is intended to be inclusive when used in a series and can be used interchangeably with “and/or,” unless explicitly stated otherwise (e.g., if used in combination with “either” or “only one of”).

What is claimed:

1. A method for candidate information exchange comprising:
receiving into memory information associated with a first candidate;
storing in a first database, said information associated with said first candidate;
enabling access to said information associated with said first candidate by a first user profile;
extracting abstract data from said information associated with said first candidate to identify extracted abstract data;
storing in a second database said extracted abstract data;
associating said extracted abstract data with said first user profile;
associating said extracted abstract data with a first token value;
determining whether said extracted abstract data is authorized for publication;
publishing said extracted abstract data to a publicly searchable database, if said extracted abstract data is authorized for publication;
receiving a request from a second user profile to transfer information associated with said first candidate;
receiving said first token value to said first user profile; and
in response to receipt of said first token value to said first user profile, transferring said information associated with said first candidate to said second user profile.

2. (canceled)

3. The method of claim 1 further comprising:
in response to receipt of said first token value to said first user profile, disassociating said extracted abstract data with said first user profile.

4. The method of claim 3 further comprising:
in response to receipt of said first token value to said first user profile, associating said extracted abstract data with said second user profile.

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A device for candidate information exchange comprising:
one or more processors configured to:
receive into memory information associated with a first candidate;
store in a first database, said information associated with said first candidate;
enable access to said information associated with said first candidate by a first user profile;
extract abstract data from said information associated with said first candidate to identify extracted abstract data;
store in a second database said extracted abstract data;
associate said extracted abstract data with said first user profile;
associate said extracted abstract data with a first token value;
determine whether said extracted abstract data is authorized for publication;
publish said extracted abstract data to a publicly searchable database, if said extracted abstract data is authorized for publication;
receive a request from a second user profile to transfer information associated with said first candidate;
receive said first token value to said first user profile; and
in response to receipt of said first token value to said first user profile, transfer said information associated with said first candidate to said second user profile.

18. The device of claim 17, wherein the one or more processors are further configured to:
in response to receipt of said first token value to said first user profile, delete said extracted abstract data from said publicly searchable database.

19. The device of claim 17, wherein the one or more processors are further configured to:
in response to receipt of said first token value to said first user profile, disassociate said extracted abstract data with said first user profile.

20. The device of claim 19, wherein the one or more processors are further configured to:
in response to receipt of said first token value to said first user profile, associate said extracted abstract data with said second user profile.

21. The device of claim 17, wherein the one or more processors are further configured to:
in response to receipt of said first token value to said first user profile, disable access to said information associated with said first candidate by said first user profile.

22. The device of claim 21, wherein the one or more processors are further configured to:
in response to receipt of said first token value to said first user profile, enable access to said information associated with said first candidate by said second user profile.

23. The device of claim 17, wherein said token value is based, at least in part, on said extracted data.

24. The device of claim 17, wherein a prescribed lease period is associated with said first token value.

25. The device of claim 24, wherein the one or more processors are further configured to:
in response to receipt of said first token value to said first user profile, temporarily disassociate said extracted abstract data with said first user profile for said prescribed lease period.

26. The device of claim 25, wherein the one or more processors are further configured to:
in response to receipt of said first token value to said first user profile, temporarily associate said extracted abstract data with said second user profile for said prescribed lease period.

27. The device of claim 26, wherein the one or more processors are further configured to:
in response to conclusion of said prescribed lease period, automatically disassociate said extracted abstract data with said second user profile.

28. The device of claim 24, wherein the one or more processors are further configured to:
in response to receipt of said first token value to said first user profile, temporarily disable access to said information associated with said first candidate by said first user profile for said prescribed lease period.

29. The device of claim 28, wherein the one or more processors are further configured to:
in response to receipt of said first token value to said first user profile, temporarily enable access to said information associated with said first candidate by said second user profile for said prescribed lease period.

30. The device of claim 24, wherein the one or more processors are further configured to:
in response to conclusion of said prescribed lease period, automatically disable access to said information associated with said first candidate by said second user profile.

31. The device of claim 24, wherein said token value is based, at least in part, on said prescribed lease period.

32. The device of claim 31, wherein said token value is based, at least in part, on said extracted data.

33. A system for candidate information exchange comprising:
one or more processors configured to:
receive into memory information associated with a first candidate;
store in a first database, said information associated with said first candidate;
enable access to said information associated with said first candidate by a first user profile;
extract abstract data from said information associated with said first candidate to identify extracted abstract data;
store in a second database said extracted abstract data;
associate said extracted abstract data with said first user profile;
associate said extracted abstract data with a first token value;
determine whether said extracted abstract data is authorized for publication;
publish said extracted abstract data to a publicly searchable database, if said extracted abstract data is authorized for publication;
receive a request from a second user profile to transfer information associated with said first candidate;
receive said first token value to said first user profile; and
in response to receipt of said first token value to said first user profile, transfer said information associated with said first candidate to said second user profile.

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)
